(19) United States
(12) Patent Application Publication
(10) Pub. No.: US 2010/0186432 A1
(43) Pub. Date: Jul. 29, 2010

(54) COMPOSITIONS COMPRISING FLUOROOLEFINS

(75) Inventors: Deepak Perti, Hockessin, DE (US); Barbara Haviland Minor, Elkton, MD (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, WILMINGTON, DE (US)

(21) Appl. No.: 12/669,190

(22) PCT Filed: Jul. 25, 2008
(86) PCT No.: PCT/US08/71098

§ 371 Date: Jan. 15, 2010

Related U.S. Application Data
(60) Provisional application No. 60/962,204, filed on Jul. 27, 2007.

(51) Int. Cl. F25B 1/00; C09K 5/04; C09K 5/00

(52) U.S. Cl. 62/115; 252/67; 252/68

(57) ABSTRACT

Disclosed are compositions comprising HFC-1225ye and other compounds that are useful as heat transfer fluids, including refrigerants, in a flooded evaporator chiller, a direct expansion chiller or a closed loop heat transfer system, such as a mobile air conditioning system. The compositions are also useful as cleaning solvents, aerosol propellants, foam blowing agents, fire extinguishing or suppression agents and sterilants. Also disclosed are methods for producing cooling and methods for replacing HFC-134a in a flooded evaporator chiller, a direct expansion chiller or a closed loop heat transfer system using such compositions.

### CROSS REFERENCE TO RELATED APPLICATIONS

This application claims the priority benefit of U.S. Provisional Application 60/962,204, filed Jul. 27, 2007.

### BACKGROUND OF THE INVENTION

1. Field of the Invention

The present disclosure relates to the field of low GWP refrigerant compositions comprising at least one fluoroolefin, and the use of these compositions. These compositions are useful as low GWP replacements in equipment designed for 1,1,1,2-tetrafluoroethane, including flooded evaporator chillers, direct expansion chillers and closed loop heat transfer systems.

2. Description of Related Art

Working fluids for various applications are being sought that have little if any environmental impact. The hydrofluorocarbon working fluids adopted as replacements for chlorofluorocarbons, have no ozone depletion potential, but have been found to contribute to global warming.

Therefore, replacements are sought for the hydrofluorocarbons currently in use as refrigerants, heat transfer fluids, cleaning solvents, aerosol propellants, foam blowing agents and fire extinguishing or suppression agents.

In order to serve as drop-in replacements in existing equipment, replacements must be close to or match the properties of the original working fluid for which the equipment was designed. It would be desirable to identify compositions that provide a balance of properties that will allow replacement of existing refrigerants and also to serve as refrigerants in new equipment designed for similar applications.

### SUMMARY OF THE INVENTION

The present invention provides for particular fluoroolefin compositions, and in particular, refrigerants for replacing 1,1,1,2-tetrafluoroethane, which have a low global warming potential (GWP) and similar energy efficiency and refrigeration capacity to the refrigerant being replaced. In addition, the present invention provides for refrigerants having low or a specified amount of glide for heat transfer systems with heat exchangers (i.e., evaporators or condensers) that are optimized to take advantage of glide.

In particular, the compositions disclosed herein may be useful for replacing R134a as a working fluid in a flooded evaporator chiller, a direct expansion (DX) chiller or a closed loop heat transfer system. Compositions as disclosed herein may be useful in new or existing equipment.

According to the present invention, there is provided a composition, which can be any of the following:

a. about 50 weight percent to about 99 weight percent 1,2,3,3,3-pentafluoropropene and about 50 weight percent to about 1 weight percent 2,3,3,3-tetrafluoropropene;

b. 1,2,3,3,3-pentafluoropropene and pentafluoroethane;

c. 1,2,3,3,3-pentafluoropropene and cyclopropane;

d. 1,2,3,3,3-pentafluoropropene and propylene;

e. 1,2,3,3,3-pentafluoropropene and fluoroethane;

f. 1,2,3,3,3-pentafluoropropene and propylene;

g. 1,2,3,3,3-pentafluoropropene, 1,1,1,2-tetrafluoroethane and pentafluoroethane;

h. 1,2,3,3,3-pentafluoropropene, 1,1,1,2-tetrafluoroethane and fluoroethane;

i. 1,2,3,3,3-pentafluoropropene, 1,1,1,2-tetrafluoroethane and cyclopropane;

j. 1,2,3,3,3-pentafluoropropene, 1,1,1,2-tetrafluoroethane and ammonia;

k. 1,2,3,3,3-pentafluoropropene, 1,1,1,2-tetrafluoroethane and propylene;

l. 1,2,3,3,3-pentafluoropropene, 1,1,1,2-tetrafluoroethane, pentafluoroethane and ammonia;

m. 1,2,3,3,3-pentafluoropropene, 1,1,1,2-tetrafluoroethane, pentafluoroethane and cyclopropane;

n. 1,2,3,3,3-pentafluoropropene, 1,1,1,2-tetrafluoroethane, pentafluoroethane and propane;

o. 1,2,3,3,3-pentafluoropropene, 1,1,1,2-tetrafluoroethane, pentafluoroethane and propylene; or

p. 1,2,3,3,3-pentafluoropropene, 1,1,1,2-tetrafluoroethane, pentafluoroethane and difluoromethane.

Further in accordance with the present invention, there is provided a composition consisting essentially of any of the following:

a. 1,2,3,3,3-pentafluoropropene and pentafluoroethane;

b. 1,2,3,3,3-pentafluoropropene and ammonia; or

c. 1,2,3,3,3-pentafluoropropene and 1,1,-difluoroethane.

The present disclosure further provides a method for producing cooling in a mobile air conditioning system, comprising evaporating a composition in the vicinity of a body to be cooled and thereafter condensing said composition, wherein the composition can be any of the above compositions.

The present disclosure further provides a method for producing cooling in a flooded evaporator chiller, comprising passing a cooling medium through an evaporator, evaporating a composition to form a vapor, thereby cooling the cooling medium, and passing the cooling medium out of the evaporator to a body to be cooled, wherein the composition can be any of the above compositions.

The present disclosure further provides a method for producing cooling in a direct expansion chiller comprising passing a composition through an evaporator, evaporating a cooling medium in the evaporator to form a cooling medium vapor, thereby cooling the composition, and passing the composition out of the evaporator to a body to be cooled, wherein the composition can be any of the above compositions.

The present disclosure further provides a method for replacing HFC-134a in a flooded evaporator chiller, a direct expansion chiller or a closed loop heat transfer system. The method comprises providing a composition, which can be any of the above compositions, to a flooded evaporator chiller, direct expansion chiller or closed loop heat transfer system in place of HFC-134a.

Further in accordance with the present invention, there is provided an alternate composition which may be any of the following:

a. 1,2,3,3,3-pentafluoropropene and difluoromethane;

b. 1,2,3,3,3-pentafluoropropene and pentafluoroethane;

c. 1,2,3,3,3-pentafluoropropene and 1,1,1,2-tetrafluoroethane;

d. 1,2,3,3,3-pentafluoropropene and 1,1,difluoroethane

e. 1,2,3,3,3-pentafluoropropene and cyclopropane;

f. 1,2,3,3,3-pentafluoropropene and propane;

g. 1,2,3,3,3-pentafluoropropene, 2,3,3,3,-tetrafluoropropene and 1,1,1,2-tetrafluoroethane;

h. 1,2,3,3,3-pentafluoropropene, 1,1,1,2-tetrafluoroethane and difluoromethane;

i. 1,2,3,3,3-pentafluoropropene, 1,1,1,2-tetrafluoroethane and 1,1,difluoroethane;

k. 1,2,3,3,3-pentafluoropropene, 1,1,1,2-tetrafluoroethane and fluoroethane; or

l. 1,2,3,3,3-pentafluoropropene, 1,1,1,2-tetrafluoroethane and propane.

The present disclosure also provide for a method for producing cooling in a flooded evaporator chiller, a method for producing cooling in a direct expansion chiller, and a method for replacing HFC-134a in either a flooded evaporator chiller or a direct expansion chiller, using any of the alternate compositions listed immediately above.

### BRIEF DESCRIPTION OF THE DRAWINGS

FIG. 1 is a schematic diagram of a flooded evaporator chiller which utilizes the refrigerant compositions of the present invention.

FIG. 2 is a schematic diagram of a direct expansion evaporator chiller which utilizes the refrigerant compositions of the present invention.

FIG. 3 is a schematic diagram of a closed loop heat transfer system which utilizes the refrigerant compositions of the present invention.

### DETAILED DESCRIPTION OF THE INVENTION

Before addressing details of embodiments described below, some terms are defined or clarified.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100 year time horizon is commonly the value referenced.

Refrigeration capacity (sometimes referred to as cooling capacity) is a term to define the change in enthalpy of a refrigerant in an evaporator per pound of refrigerant circulated, i.e., the heat removed by the refrigerant in the evaporator per a given period of time. The refrigeration capacity is a measure of the ability of a refrigerant or heat transfer composition to produce cooling. Therefore, the higher the capacity, the greater the cooling that may be produced.

Coefficient of performance (COP) is the amount of heat removed divided by the required energy input to operate the cycle. The higher the COP, the higher the energy efficiency. COP is directly related to the energy efficiency ratio (EER), that is, the efficiency rating for refrigeration or air conditioning equipment at a specific set of internal and external temperatures.

Glide is the change in refrigerant temperature across an evaporator or condenser as the refrigerant is evaporating or condensing. Specifically, refrigerant glide in a condenser is the difference between its dew point and bubble point temperatures at the condensing pressure, while in an evaporator, it is the difference between the inlet temperature and the saturated vapor temperature at the evaporating pressure. Pure compound refrigerants have zero glide as do azeotrope compositions at specific temperatures and pressures. Near-azeotrope (sometimes referred to as azeotrope-like) compositions that behave similarly to azeotropes, will have low glide. Compositions that are non-azeotropes (or zeotropes) may have significantly higher glide. Average glide is meant to mean the average of glide in the evaporator and glide in the condenser.

As used herein, a non-azeotropic composition comprises one that is not azeotropic and also not near-azeotropic, meaning that it behaves as a simple mixture of components and thus will fractionate during evaporation or boiling off. During leakage from a heat transfer system this fractionation will cause the lower boiling (higher vapor pressure) component to leak out of the apparatus first. Thus, the vapor pressure of the heat transfer composition remaining inside the heat transfer system will be reduced. This drop in pressure can be measured and used as an early indication of a leak.

As used herein, an azeotropic composition comprises a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a heat transfer system during operation, which may reduce efficiency of the system. Additionally, an azeotropic composition will not fractionate upon leakage from a heat transfer system.

As used herein, a near-azeotropic composition (also commonly referred to as an “azeotrope-like composition”) comprises a substantially constant boiling liquid admixture of two or more substances that behaves essentially as a single substance. One way to characterize a near-azeotropic composition is that the vapor produced by partial evaporation or distillation of the liquid has substantially the same composition as the liquid from which it was evaporated or distilled, that is, the admixture distills/refluxes without substantial composition change. Another way to characterize a near-azeotropic composition is that the bubble point vapor pressure and the dew point vapor pressure of the composition at a particular temperature are substantially the same. Herein, a composition is near-azeotropic if, after 50 weight percent of the composition is removed, such as by evaporation or boiling off, the difference in vapor pressure between the original composition and the composition remaining after 50 weight percent of the original composition has been removed is less than about 10 percent.

As used herein, a heat transfer system may be any refrigeration system, refrigerator, air conditioning system, air conditioner, heat pump, chiller, and the like utilizing a heat transfer composition.

As used herein, a heat transfer composition comprises a composition used to carry heat from a heat source to a heat sink.

As used herein, a refrigerant comprises a compound or mixture of compounds that function as a heat transfer composition in a cycle wherein the composition undergoes a phase change from a liquid to a gas and back.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

### Compositions

According to one embodiment of the present invention, the present disclosure relates to compositions comprising 1,2,3,3,3-pentafluoropropene (CF₃CF═CHF, HFC-1225ye, or R1225ye) and at least one additional compound. These additional compounds are shown in Table 1.

TABLE 1

| | | | Other |
|---|---|---|---|
| Code | Structure | Name | designation |
| HFC-1234yf | CF₃CF═CH₂ | 2,3,3,3- | R1234yf |
| | | tetrafluoropropene | |
| HFC-32 | CH₂F₂ | Difluoromethane | R32 |
| HFC-125 | CF₃CHF₂ | Pentafluoroethane | R125 |
| HFC-134a | CF₃CH₂F | 1,1,1,2- | R134a |
| | | tetrafluoroethane | |
| HFC-152a | CHF₂CH₃ | 1,1-difluoroethane | R152a |
| HFC-161 | CH₂FCH₃ | Fluoroethane | R161 |
| HC-290 | CH₃CH₂CH₃ | Propane | R290 |
| HC-C270 | Cyclo- | Cyclopropane | RC270 |
| | CH₂CH₂CH₂— | | |
| HC-1270 | CH₃CH═CH₂ | Propylene | R1270 |
| | NH₃ | Ammonia | R717 |

The compounds of Table 1 may be prepared by methods known in the art or are commercially available.

According to this embodiment, the compositions of the present invention may comprise or consist essentially of (meaning that there may be minor amounts of other components):

a. about 50 weight percent to about 99 weight percent 1,2,3,3,3-pentafluoropropene and about 50 weight percent to about 1 weight percent 2,3,3,3-tetrafluoropropene;

b. 1,2,3,3,3-pentafluoropropene and pentafluoroethane;

c. 1,2,3,3,3-pentafluoropropene and cyclopropane;

d. 1,2,3,3,3-pentafluoropropene and propylene;

e. 1,2,3,3,3-pentafluoropropene and fluoroethane;

f. 1,2,3,3,3-pentafluoropropene and propylene;

g. 1,2,3,3,3-pentafluoropropene, 1,1,1,2-tetrafluoroethane and pentafluoroethane;

h. 1,2,3,3,3-pentafluoropropene, 1,1,1,2-tetrafluoroethane, and fluoroethane;

i. 1,2,3,3,3-pentafluoropropene, 1,1,1,2-tetrafluoroethane, and cyclopropane;

j. 1,2,3,3,3-pentafluoropropene, 1,1,1,2-tetrafluoroethane, and ammonia;

k. 1,2,3,3,3-pentafluoropropene, 1,1,1,2-tetrafluoroethane, and propylene;

l. 1,2,3,3,3-pentafluoropropene, 1,1,1,2-tetrafluoroethane, pentafluoroethane, and ammonia;

m. 1,2,3,3,3-pentafluoropropene, 1,1,1,2-tetrafluoroethane, pentafluoroethane, and cyclopropane;

n. 1,2,3,3,3-pentafluoropropene, 1,1,1,2-tetrafluoroethane, pentafluoroethane, and propane;

o. 1,2,3,3,3-pentafluoropropene, 1,1,1,2-tetrafluoroethane, pentafluoroethane, and propylene; or

p. 1,2,3,3,3-pentafluoropropene, 1,1,1,2-tetrafluoroethane, pentafluoroethane, and difluoromethane.

Alternatively, the compositions of the present invention may consist essentially of:

q. 1,2,3,3,3-pentafluoropropene and pentafluoroethane;

r. 1,2,3,3,3-pentafluoropropene and ammonia;

or

s. 1,2,3,3,3-pentafluoropropene and 1,1,-difluoroethane.

The compositions of this embodiment shall be referred to hereinafter as Compositions of Group A.

HFC-1225ye exists as two different configurational isomers, Z-(trans) or E-(cis). As used herein, HFC-1225ye is meant to be Z-HFC-1225ye, E-HFC-1225ye, or any combination thereof. In one embodiment, HFC-1225ye is Z-HFC-1225ye. In another embodiment, HFC-1225ye is E-HFC-1225ye. In another embodiment, HFC-1225ye is a combination of Z-HFC-1225ye and E-HFC-1225ye. In another embodiment, HFC-1225ye is a mixture of the isomers that is predominantly (greater than 50%, preferably greater than 90%) Z-HFC-1225ye.

HFC-1225ye may be made by processes known in the art, for instance by thermal or catalytic dehydrofluorination of 1,1,1,2,2,3-hexafluoropropane or 1,1,1,2,3,3-hexafluoropropane.

According to another embodiment, the present disclosure relates to compositions comprising 1,2,3,3,3-pentafluoropropene (CF₃CF═CHF, HFC-1225ye, or R1225ye) and at least one additional compound. These additional compounds compositions according to this embodiment and described herein are listed in Table 1 above.

According to this embodiment, the compositions of the present invention may comprise or consist essentially of (meaning that there may be minor amounts of other components):

a. 1,2,3,3,3-pentafluoropropene and difluoromethane;

b. 1,2,3,3,3-pentafluoropropene and pentafluoroethane;

c. 1,2,3,3,3-pentafluoropropene and 1,1,1,2-tetrafluoroethane;

d. 1,2,3,3,3-pentafluoropropene and 1,1,difluoroethane

e. 1,2,3,3,3-pentafluoropropene and cyclopropane;

f. 1,2,3,3,3-pentafluoropropene and propane;

g. 1,2,3,3,3-pentafluoropropene, 2,3,3,3,-tetrafluoropropene and 1,1,1,2-tetrafluoroethane;

h. 1,2,3,3,3-pentafluoropropene, 1,1,1,2-tetrafluoroethane and difluoromethane;

i. 1,2,3,3,3-pentafluoropropene, 1,1,1,2-tetrafluoroethane and 1,1,difluoroethane;

j. 1,2,3,3,3-pentafluoropropene, 1,1,1,2-tetrafluoroethane and fluoroethane; and

k. 1,2,3,3,3-pentafluoropropene, 1,1,1,2-tetrafluoroethane and propane.

The compositions of this embodiment shall be referred to hereinafter as compositions of Group B.

Specific weight percent ranges for the compositions of Group A and of Group B are given in Table 2. It is within the scope of the present invention to include those ranges which are included within any of the ranges given below.

TABLE 2

| | | Alternate Range A | Alternate Range B |
|---|---|---|---|
| Composition | Range (wt %) | (wt %) | (wt %) |
| R1225ye/R1234yf | 50-99/50-1 | 50-80/20-50 | 60-80/40-20 |
| R1225ye/R32 | 80-99/20-1 | 84-99/16-1 | |
| R1225ye/R125 | 80-99/20-1 | 84-99/16-1 | 92-99/8-1 |
| R1225ye/R134a | 50-99/50-1 | 50-95/50-5 | 80-95/20-5 |
| R1225ye/R152a | 90-99/1-10 | 92-99/8-1 | 96-99/4-1 |
| R1225ye/R161 | 90-99/1-10 | 92-99/8-1 | 96-99/4-1 |
| R1225ye/RC270 | 90-99/1-10 | 92-99/8-1 | 98-99/2-1 |
| R1225ye/R717 | 90-99/1-10 | 96-99/4-1 | 98-99/2-1 |
| R1225ye/R290 | 90-99/1-10 | 96-99/4-1 | 98-99/2-1 |
| R1225ye/R1270 | 90-99/1-10 | 96-99/4-1 | 98-99/2-1 |
| R1225ye/R134a/R1234yf | 1-60/20-50/1-50 | 5-48/5-50/25-48 | 40-48/5-20/40-48 |
| R1225ye/R134a/R32 | 40-98/1-50/1-10 | 42-94/5-50/1-8 | 72-94/5-20/1-8 |
| R1225ye/R134a/R125 | 40-98/1-50/1-20 | 49-94/5-50/1-16 | 72-94/5-20/1-8 |
| R1225ye/R134a/R152a | 40-98/1-50/1-10 | 42-94/5-50/1-8 | 76-94/5-20/1-4 |
| R1225ye/R134a/R161 | 40-98/1-50/1-10 | 42-94/5-50/1-8 | 76-94/5-20/1-4 |
| R1225ye/R134a/C270 | 40-98/1-50/1-10 | 42-94/5-50/1-8 | 78-94/5-20/1-2 |
| R1225ye/R134a/R717 | 40-98/1-50/1-5 | 46-94/5-50/1-4 | 78-94/5-20/1-2 |
| R1225ye/R134a/R290 | 40-98/1-50/1-5 | 46-94/5-50/1-4 | 78-94/5-20/1-2 |
| R1225ye/R134a/R1270 | 40-98/1-50/1-5 | 46-94/5-50/1-4 | 78-94/5-20/1-2 |
| R1225ye/R134a/R125/R717 | 40-97/1-50/1-20/1-5 | 47-93/5-50/1-16/1-2 | 70-93/5-20/1-8/1-2 |
| R1225ye/R134a/R125/RC270 | 40-97/1-50/1-20/1-5 | 47-93/5-50/1-16/1-2 | 70-93/5-20/1-8/1-2 |
| R1225ye/R134a/R125/R290 | 40-97/1-50/1-20/1-5 | 47-93/5-50/1-16/1-2 | 70-93/5-20/1-8/1-2 |
| R1225ye/R134a/R125/ | 40-97/1-50/1-20/1-5 | 47-93/5-50/1-16/1-2 | 70-93/5-20/1-8/1-2 |
| R1270 | | | |
| R1225ye/R134a/R125/R32 | 40-97/1-50/1-20/1-10 | 48-93/5-50/1-16/1-4 | 68-93/5-20/1-8/1-4 |

The present invention provides compositions of both Group A and Group B that have zero or low ozone depletion potential and low global warming potential (GWP). The compositions as disclosed herein will have global warming potentials that are less than many hydrofluorocarbon refrigerants currently in use. Typically, fluoroolefins, such as HFC-1225ye, are expected to have GWP of less than about 25. One aspect of the present invention is to provide a composition with a global warming potential of less than 1000, less than 500, less than 150, less than 100, or less than 50.

In addition, non-flammability and low GWP are both desirable properties for compositions when used as refrigerants. R1234yf, R32, R152a, R161, R717, and the hydrocarbons (R290, RC270, and R1270) are all known to be flammable compounds. In one embodiment, those compositions provided in Alternate range B of Table 2 that contain these flammable compounds are expected to be non-flammable. R125 and R134a are known to have high GWP's (i.e., GWP equal to 3400 and 1300 respectively). In another embodiment, those compositions provided in alternate range B of Table 2 that contain R125 or R134a are expected to be more acceptable in the cooling industry based upon GWP of the overall composition.

The compositions of Group A and of Group B of the present invention may be prepared by any convenient method to combine the desired amounts of the individual components as set forth in Table 2. A preferred method is to weigh the desired component amounts and thereafter combine the components in an appropriate vessel. Agitation may be used, if desired.

Compositions of Group A and of Group B as disclosed herein may be used in combination with a desiccant in a refrigeration, air-conditioning, or heat pump system to aid in removal of moisture. Desiccants may be composed of activated alumina, silica gel, or zeolite-based molecular sieves. Representative molecular sieves include MOLSIV XH-7, XH-6, XH-9 and XH-11 (UOP LLC, Des Plaines, Ill.). For refrigerants with small molecular size such as HFC-32, XH-11 desiccant is preferred.

The compositions of Group A and of Group B as disclosed here may further comprise at lease one lubricant selected from the group consisting of polyalkylene glycols, polyol esters, polyvinylethers, mineral oils, alkylbenzenes, synthetic paraffins, synthetic naphthenes, and poly(alpha)olefins.

Lubricants of the present invention comprise those suitable for use with refrigeration or air-conditioning apparatus. Among these lubricants are those conventionally used in vapor compression refrigeration apparatus utilizing chlorofluorocarbon refrigerants. Lubricants of the present invention may comprise those commonly known as “mineral oils” in the field of compression refrigeration lubrication. Mineral oils comprise paraffins (i.e., straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and naphthenes, and poly(alphaolefins). Representative conventional lubricants of the present invention are the commercially available BVM 100 N (paraffinic mineral oil sold by BVA Oils), napthenic mineral oil commercially available from Crompton Co. under the trademarks Suniso® 3GS and Suniso® 5GS, naphthenic mineral oil commercially available from Pennzoil under the trademark Sontex® 372LT, napthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500, and HAB 22 (branched alkylbenzene sold by Nippon Oil).

Lubricants of the present invention further comprise those, which have been designed for use with hydrofluorocarbon refrigerants and are miscible with refrigerants of the present invention under compression refrigeration and air-conditioning apparatus' operating conditions. Such lubricants include, but are not limited to, polyol esters (POEs) such as Castrol® 100 (Castrol, United Kingdom), polyalkylene glycols (PAGs) such as RL-488A from Dow (Dow Chemical, Midland, Mich.), polyvinyl ethers (PVEs), and polycarbonates (PCs).

Lubricants used with compositions of Group A and Group B of the present invention are selected by considering a given compressor's requirements and the environment to which the lubricant will be exposed.

Those compositions of Group A and of Group B described herein containing hydrocarbons may provide improved miscibility with conventional refrigeration lubricants, such as mineral oil. Thus, use of these hydrocarbon-containing compositions for retrofit of existing equipment would not require the costly and time consuming lubricant change out process.

The compositions of Group A and of Group B as disclosed herein may further comprise an additive selected from the group consisting of compatibilizers, UV dyes, solubilizing agents, tracers, stabilizers, perfluoropolyethers (PFPE), and functionalized perfluoropolyethers.

The compositions of Group A and of Group B of the present invention may further comprise about 0.01 weight percent to about 5 weight percent of a stabilizer, free radical scavenger or antioxidant. Such other additives include but are not limited to, nitromethane, hindered phenols, hydroxylamines, thiols, phosphites, or lactones. Single additives or combinations may be used.

Optionally, certain refrigeration or air-conditioning system additives may be added, as desired, to compositions of the present invention in order to enhance performance and system stability. These additives are known in the field of refrigeration and air-conditioning, and include, but are not limited to, anti wear agents, extreme pressure lubricants, corrosion and oxidation inhibitors, metal surface deactivators, free radical scavengers, and foam control agents. In general, these additives may be present in the inventive compositions in small amounts relative to the overall composition. Typically concentrations of from less than about 0.1 weight percent to as much as about 3 weight percent of each additive are used. These additives are selected on the basis of the individual system requirements. These additives include members of the triaryl phosphate family of EP (extreme pressure) lubricity additives, such as butylated triphenyl phosphates (BTPP), or other alkylated triaryl phosphate esters, e.g. Syn-0-Ad 8478 from Akzo Chemicals, tricresyl phosphates and related compounds. Additionally, the metal dialkyl dithiophosphates (e.g., zinc dialkyl dithiophosphate (or ZDDP), Lubrizol 1375 and other members of this family of chemicals may be used in compositions of the present invention. Other antiwear additives include natural product oils and asymmetrical polyhydroxyl lubrication additives, such as Synergol TMS (International Lubricants). Similarly, stabilizers such as antioxidants, free radical scavengers, and water scavengers may be employed. Compounds in this category can include, but are not limited to, butylated hydroxy toluene (BHT), epoxides, and mixtures thereof. Corrosion inhibitors include dodeceyl succinic acid (DDSA), amine phosphate (AP), oleoyl sarcosine, imidazone derivatives and substituted sulfphonates. Metal surface deactivators include areoxalyl bis(benzylidene)hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof.

Additional additives include stabilizers comprising at least one compound selected from the group consisting of hindered phenols, thiophosphates, butylated triphenylphosphorothionates, organo phosphates, or phosphites, aryl alkyl ethers, terpenes, terpenoids, epoxides, fluorinated epoxides, oxetanes, ascorbic acid, thiols, lactones, thioethers, amines, nitromethane, alkylsilanes, benzophenone derivatives, aryl sulfides, divinyl terephthalic acid, diphenyl terephthalic acid, ionic liquids, and mixtures thereof. Representative stabilizer compounds include but are not limited to tocopherol; hydroquinone; t-butyl hydroquinone; monothiophosphates; and dithiophosphates, commercially available from Ciba Specialty Chemicals, Basel, Switzerland, hereinafter “Ciba”, under the trademark Irgalube® 63; dialkylthiophosphate esters, commercially available from Ciba under the trademarks Irgalube® 353 and Irgalube® 350, respectively; butylated triphenylphosphorothionates, commercially available from Ciba under the trademark Irgalube® 232; amine phosphates, commercially available from Ciba under the trademark Irgalube® 349 (Ciba); hindered phosphites, commercially available from Ciba as Irgafos® 168; a phosphate such as (Tris-(di-tert-butylphenyl), commercially available from Ciba under the trademark Irgafos® OPH; (Di-n-octyl phosphite); and iso-decyl diphenyl phosphite, commercially available from Ciba under the trademark Irgafos® DDPP; anisole; 1,4-dimethoxybenzene; 1,4-diethoxybenzene; 1,3,5-trimethoxybenzene; d-limonene; retinal; pinene; menthol; Vitamin A; terpinene; dipentene; lycopene; beta carotene; bornane; 1,2-propylene oxide; 1,2-butylene oxide; n-butyl glycidyl ether; trifluoromethyloxirane; 1,1-bis(trifluoromethyl)oxirane; 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); 3-ethyl-3-((2-ethyl-hexyloxy)methyl)-oxetane, such as OXT-212 (Toagosei Co., Ltd); ascorbic acid; methanethiol (methyl mercaptan); ethanethiol (ethyl mercaptan); Coenzyme A; dimercaptosuccinic acid (DMSA); grapefruit mercaptan ((R)-2-(4-methylcyclohex-3-enyl)propane-2-thiol)); cysteine ((R)-2-amino-3-sulfanyl-propanoic acid); lipoamide(1,2-dithiolane-3-pentanamide); 5,7-bis(1,1-dimethylethyl)-3-[2,3(or 3,4)-dimethylphenyl]-2(3H)-benzofuranone, commercially available from Ciba under the trademark Irganox® HP-136; benzyl phenyl sulfide; diphenyl sulfide; diisopropylamine; dioctadecyl 3,3′-thiodipropionate, commercially available from Ciba under the trademark Irganox® PS 802 (Ciba); didodecyl 3,3′-thiopropionate, commercially available from Ciba under the trademark Irganox® PS 800; di-(2,2,6,6-tetramethyl-4-piperidyl)sebacate, commercially available from Ciba under the trademark Tinuvin® 770; poly-(N-hydroxyethyl-2,2,6,6-tetramethyl-4-hydroxy-piperidyl succinate, commercially available from Ciba under the trademark Tinuvin® 622LD (Ciba); methyl bis tallow amine; bis tallow amine; phenol-alpha-naphthylamine; bis(dimethylamino)methylsilane (DMAMS); tris(trimethylsilyl)silane (TTMSS); vinyltriethoxysilane; vinyltrimethoxysilane; 2,5-difluorobenzophenone; 2′,5′-dihydroxyacetophenone; 2-aminobenzophenone; 2-chlorobenzophenone; benzyl phenyl sulfide; diphenyl sulfide; dibenzyl sulfide; ionic liquids; and others.

Ionic liquid stabilizers comprise at least one ionic liquid. Ionic liquids are organic salts that are liquid at room temperature (approximately 25° C.). In another embodiment, ionic liquid stabilizers comprise salts containing cations selected from the group consisting of pyridinium, pyridazinium, pyrimidinium, pyrazinium, imidazolium, pyrazolium, thiazolium, oxazolium and triazolium; and anions selected from the group consisting of [BF₄]—, [PF₆]—, [SbF₆]—, [CF₃SO₃]—, [HCF₂CF₂SO₃]—, [CF₃HFCCF₂SO₃]—, [HCClFCF₂SO₃]—, [(CF₃SO₂)₂N]—, [(CF₃CF₂SO₂)₂N]—, [(CF₃SO₂)₃C]—, [CF₃CO₂]—, and F—. Representative ionic liquid stabilizers include emim BF₄ (1-ethyl-3-methylimidazolium tetrafluoroborate); bmim BF₄(1-butyl-3-methylimidazolium tetraborate); emim PF₆ (1-ethyl-3-methylimidazolium hexafluorophosphate); and bmim PF₆(1-butyl-3-methylimidazolium hexafluorophosphate), all of which are available from Fluka (Sigma-Aldrich).

In one embodiment, the compositions of Group A and of Group B as disclosed herein may further comprise a perfluoropolyether. A common characteristic of perfluoropolyethers is the presence of perfluoroalkyl ether moieties. Perfluoropolyether is synonymous to perfluoropolyalkylether. Other synonymous terms frequently used include “PFPE”, “PFAE”, “PFPE oil”, “PFPE fluid”, and “PFPAE”. For example, a perfluoropolyether, having the formula of CF₃—(CF₂)₂—O—[CF(CF₃)—CF₂—O]j′—R′f, is commercially available from DuPont under the trademark Krytox® In the formula, j′ is 2-100, inclusive and R′f is CF₂CF₃, a C3 to C6 perfluoroalkyl group, or combinations thereof.

Other PFPEs, commercially available from Ausimont of Milan, Italy, under the trademarks Fomblin® and Galden®, and produced by perfluoroolefin photooxidation, can also be used. PFPE commercially available under the trademark Fomblin®-Y can have the formula of CF₃O(CF₂CF(CF₃)—O—)_{m′}(CF₂—O—)_{n′}—R_{1f}. Also suitable is CF₃O[CF₂CF(CF₃)O]_{m′}(CF₂CF₂O)_{o′}(CF₂O)_{n′}—R_{1f}. In the formulae R_{1f} is CF₃, C₂F₅, C₃F₇, or combinations of two or more thereof; (m′+n′) is 8-45, inclusive; and m/n is 20-1000, inclusive; o′ is 1; (m′+n′+o′) is 8-45, inclusive; m′/n′ is 20-1000, inclusive.

PFPE commercially available under the trademark Fomblin®-Z can have the formula of CF₃O(CF₂CF₂—O—)_{p′}(CF₂—O)_{q′}CF₃ where (p′+q′) is 40-180 and p′/q′ is 0.5-2, inclusive.

Another family of PFPE, commercially available under the trademark Demnum™ from Daikin Industries, Japan, can also be used. It can be produced by sequential oligomerization and fluorination of 2,2,3,3-tetrafluorooxetane, yielding the formula of F—[(CF₂)₃—O]_{t′}—R_{2f} where R_{2f} is CF₃, C₂F₅, or combinations thereof and t′ is 2-200, inclusive.

The two end groups of the perfluoropolyether, independently, can be functionalized or unfunctionalized. In an unfunctionalized perfluoropolyether, the end group can be branched or straight chain perfluoroalkyl radical end groups. Examples of such perfluoropolyethers can have the formula of C_{r′}F_{(2r′+1)}-A-C_{r′}F_{(2r′+1)} in which each r′ is independently 3 to 6; A can be O—(CF(CF₃)CF₂—O)_{w′}, O—(CF₂—O)_{x′}(CF₂CF₂—O)_{y′}, O—(C₂F₄—O)_{w′}, O—(C₂F₄—O)_{x′}(C₃F₆—O)_{y′}, O—(CF(CF₃)CF₂—O)_{x′}(CF₂—O)_{y′}, O—(CF₂CF₂CF₂—O)_{w′}, O—(CF(CF₃)CF₂—O)_{x′}(CF₂CF₂—O)_{y′}—(CF₂—O)_{z′}, or combinations of two or more thereof; preferably A is O—(CF(CF₃)CF₂—O)_{w′}, O—(C₂F₄—O)_{w′}, O—(C₂F₄—O)_{x′}(C₃F₆—O)_{y′}, O—(CF₂CF₂CF₂—O)_{w′}, or combinations of two or more thereof; w′ is 4 to 100; x′ and y′ are each independently 1 to 100. Specific examples include, but are not limited to, F(CF(CF₃)—CF₂—O)₉—CF₂CF₃, F(CF(CF₃)—CF₂—O)₉—CF(CF₃)₂, and combinations thereof. In such PFPEs, up to 30% of the halogen atoms can be halogens other than fluorine, such as, for example, chlorine atoms.

The two end groups of the perfluoropolyether, independently, can also be functionalized. A typical functionalized end group can be selected from the group consisting of esters, hydroxyls, amines, amides, cyanos, carboxylic acids and sulfonic acids.

Representative ester end groups include —COOCH₃, —COOCH₂CH₃, —CF₂COOCH₃, —CF₂COOCH₂CH₃, —CF₂CF₂COOCH₃, —CF₂CF₂COOCH₂CH₃, —CF₂CH₂COOCH₃, —CF₂CF₂CH₂COOCH₃, —CF₂CH₂CH₂COOCH₃, —CF₂CF₂CH₂CH₂COOCH₃.

Representative hydroxyl end groups include —CF₂OH, —CF₂CF₂OH, —CF₂CH₂OH, —CF₂CF₂CH₂OH, —CF₂CH₂CH₂OH, —CF₂CF₂CH₂CH₂OH.

Representative amine end groups include —CF₂NR¹R², —CF₂CF₂NR¹R², —CF₂CH₂NR¹R², —CF₂CF₂CH₂NR¹R², —CF₂CH₂CH₂NR¹R², —CF₂CF₂CH₂CH₂NR¹R², wherein R¹ and R² are independently H, CH₃, or CH₂CH₃.

Representative amide end groups include —CF₂C(O)NR¹R², —CF₂CF₂C(O)NR¹R², —CF₂CH₂C(O)NR¹R², —CF₂CF₂CH₂C(O)NR¹R², —CF₂CH₂CH₂C(O)NR¹R², —CF₂CF₂CH₂CH₂C(O)NR¹R², wherein R¹ and R² are independently H, CH₃, or CH₂CH₃.

Representative cyano end groups include —CF₂CN, —CF₂CF₂CN, —CF₂CH₂CN, —CF₂CF₂CH₂CN, —CF₂CH₂CH₂CN, —CF₂CF₂CH₂CH₂CN.

Representative carboxylic acid end groups include —CF₂COOH, —CF₂CF₂COOH, —CF₂CH₂COOH, —CF₂CF₂CH₂COOH, —CF₂CH₂CH₂COOH, —CF₂CF₂CH₂CH₂COOH.

Representative sulfonic acid end groups include —S(O)(O)OR³, —S(O)(O)R⁴, —CF₂OS(O)(O)OR³, —CF₂CF₂OS(O)(O)OR³, —CF₂CH₂O S(O)(O)OR³, —CF₂CF₂CH₂OS(O)(O)OR³, —CF₂CH₂CH₂OS(O)(O)OR³, —CF₂CF₂CH₂CH₂OS(O)(O)OR³, —CF₂S(O)(O)OR³, —CF₂CF₂S(O)(O)OR³, —CF₂CH₂S(O)(O)OR³, —CF₂CF₂CH₂S(O)(O)OR³, —CF₂CH₂CH₂S(O)(O)OR³, —CF₂CF₂CH₂CH₂S(O)(O)OR³, —CF₂OS(O)(O)R⁴, —CF₂CF₂O S(O)(O)R⁴, —CF₂CH₂OS(O)(O)R⁴, —CF₂CF₂CH₂OS(O)(O)R⁴, —CF₂CH₂CH₂OS(O)(O)R⁴, —CF₂CF₂CH₂CH₂OS(O)(O)R⁴, wherein R³ is H, CH₃, CH₂CH₃, CH₂CF₃, CF₃, or CF₂CF₃, R⁴ is CH₃, CH₂CH₃, CH₂CF₃, CF₃, or CF₂CF₃.

In one embodiment, the compositions of Group A and Group B may be used as blowing agents for use in preparing foams. Thus, according to the present invention, there is provided a foam prepared from such blowing agents, and preferably polyurethane and polyisocyanate foams, and a method of preparing such foams. In such foam embodiments, one or more of the compositions of Group A or Group B is included as a blowing agent and is added to a foamable composition, and the foamable composition is reacted under conditions effective to form a foam. Such conditions may include the use of one or more additional components capable of reacting and foaming under the proper conditions to form a foam or cellular structure. Any of the methods known in the art may be used or adapted for use in accordance with the foam embodiments of the present invention.

In another embodiment, the present disclosure to the use of the compositions of Group A or Group B as propellants in sprayable compositions. In another embodiment, the present invention relates to a sprayable composition comprising the compositions of Group A or Group B. In another embodiment, the sprayable composition further comprises the active ingredient to be sprayed together with inert ingredients, solvents and other materials. In one embodiment, the sprayable composition is an aerosol. Suitable active materials to be sprayed include, without limitations, cosmetic materials, such as deodorants, perfumes, hair sprays, cleaners, and polishing agents as well as medicinal materials such as anti-asthma and anti-halitosis medications.

In one embodiment, the present disclosure provides a process for producing aerosol products comprising the step of adding a composition of Group A or Group B to active ingredients in an aerosol container, wherein said composition functions as a propellant.

Another embodiment provides methods of suppressing a flame, said method comprising contacting a flame with a fluid comprising a composition of Group A or Group B. Any suitable methods for contacting the flame with the present composition may be used. For example, a composition as disclosed herein may be sprayed, poured, and the like onto the flame, or at least a portion of the flame may be immersed in the flame suppression composition. In light of the teachings herein, those of skill in the art will be readily able to adapt a variety of conventional apparatus and methods of flame suppression for use in the present disclosure.

A further embodiment provides methods of extinguishing or suppressing a fire in a total-flood application comprising providing an agent comprising a composition of Group A or Group B; disposing the agent in a pressurized discharge system; and discharging the agent into an area to extinguish or suppress fires in that area.

Another embodiment provides methods of inerting an area to prevent a fire or explosion comprising providing an agent comprising a composition of Group A or Group B; disposing the agent in a pressurized discharge system; and discharging the agent into the area to prevent a fire or explosion from occurring.

The term “extinguishment” is usually used to denote complete elimination of a fire; whereas, “suppression” is often used to denote reduction, but not necessarily total elimination, of a fire or explosion. As used herein, terms “extinguishment” and “suppression” will be used interchangeably. There are four general types of halocarbon fire and explosion protection applications. (1) In total-flood fire extinguishment and/or suppression applications, the agent is discharged into a space to achieve a concentration sufficient to extinguish or suppress an existing fire. Total flooding use includes protection of enclosed, potentially occupied spaces such, as computer rooms as well as specialized, often unoccupied spaces such as aircraft engine nacelles and engine compartments in vehicles. (2) In streaming applications, the agent is applied directly onto a fire or into the region of a fire. This is usually accomplished using manually operated wheeled or portable units. A second method, included as a streaming application, uses a “localized” system, which discharges agent toward a fire from one or more fixed nozzles. Localized systems may be activated either manually or automatically. (3) In explosion suppression, a composition as disclosed herein is discharged to suppress an explosion that has already been initiated. The term “suppression” is normally used in this application because the explosion is usually self-limiting. However, the use of this term does not necessarily imply that the explosion is not extinguished by the agent. In this application, a detector is usually used to detect an expanding fireball from an explosion, and the agent is discharged rapidly to suppress the explosion. Explosion suppression is used primarily, but not solely, in defense applications. (4) In inertion, a composition of Group A or Group B is discharged into a space to prevent an explosion or a fire from being initiated. Often, a system similar or identical to that used for total-flood fire extinguishment or suppression is used. Usually, the presence of a dangerous condition (for example, dangerous concentrations of flammable or explosive gases) is detected, and the composition as disclosed herein is then discharged to prevent the explosion or fire from occurring until the condition can be remedied.

The extinguishing method can be carried out by introducing the composition into an enclosed area surrounding a fire. Any of the known methods of introduction can be utilized provided that appropriate quantities of the composition are metered into the enclosed area at appropriate intervals. For example, a composition can be introduced by streaming, e.g., using conventional portable (or fixed) fire extinguishing equipment; by misting; or by flooding, e.g., by releasing (using appropriate piping, valves, and controls) the composition into an enclosed area surrounding a fire. The composition can optionally be combined with an inert propellant, e.g., nitrogen, argon, decomposition products of glycidyl azide polymers or carbon dioxide, to increase the rate of discharge of the composition from the streaming or flooding equipment utilized.

In one embodiment, the extinguishing process involves introducing a composition of Group A or Group B to a fire or flame in an amount sufficient to extinguish the fire or flame. One skilled in this field will recognize that the amount of flame suppressant needed to extinguish a particular fire will depend upon the nature and extent of the hazard. When the flame suppressant is to be introduced by flooding, cup burner test data is useful in determining the amount or concentration of flame suppressant required to extinguish a particular type and size of fire.

In one embodiment, a sterilant mixture is an azeotrope or azeotrope-like composition comprising ethylene oxide and a composition of Group A or Group B. In another embodiment, a sterilant mixture is a non-azeotrope (or zeotrope) composition comprising ethylene oxide and a composition of Group A or Group B.

In one embodiment, the sterilant mixture may be used to sterilize a great many articles, including but not limited to medical equipment and materials, such diagnostic endoscopes, plastic goods such as syringes, gloves, test tubes, incubators and pacemakers; rubber goods such as tubing, catheters and sheeting; instruments such as needles, scalpels and oxygen tests; and other items such as dilators, pumps, motors and intraocular lenses. In another embodiment, the sterilant mixture of this invention may be used as a fumigant for items outside the medical field including but not limited to certain food stuffs, such as species, and other items such as furs, bedding, paper goods, and transportation equipment such as the cargo area of airplanes, trains, and ships.

In one embodiment, the sterilant mixture may be effective against all forms of life, particularly unwanted insects, bacteria, virus, molds, fungi, and other microorganisms.

In another embodiment, the present disclosure provides a method for sterilizing an article which comprises contacting the article with a sterilant mixture comprising ethylene oxide and a composition of Group A or Group B.

In one embodiment, the method of sterilizing an article may be accomplished in any manner known in the art, including contacting the article to be sterilized to the sterilant mixture under conditions and for a period of time as to be effective in achieving the desired degree of sterility. In another embodiment, the method is effected by placing the articles to be sterilized in a vessel, evacuating the air from the vessel, humidifying the vessel, and contacting the articles to the sterilant mixture for an effective period of time. In one embodiment the humidifying creates a relative humidity within the vessel of from about 30 to about 80 percent.

An effect period of time for sterilizing will depend upon a number of factors including temperature, pressure, relative humidity, the specific sterilant mixture employed and the material being sterilized. Alternatively, some porous articles may require shorter contact times than do articles sealed in polyethylene bags. Further, in another embodiment, certain bacteria are especially resistant and may thus require longer contact times for sterilization.

In another embodiment, the compositions of Group A and of Group B may be used as refrigerants. The use of such refrigerants in cooling systems and in methods for producing cooling will be described below.

### Chillers

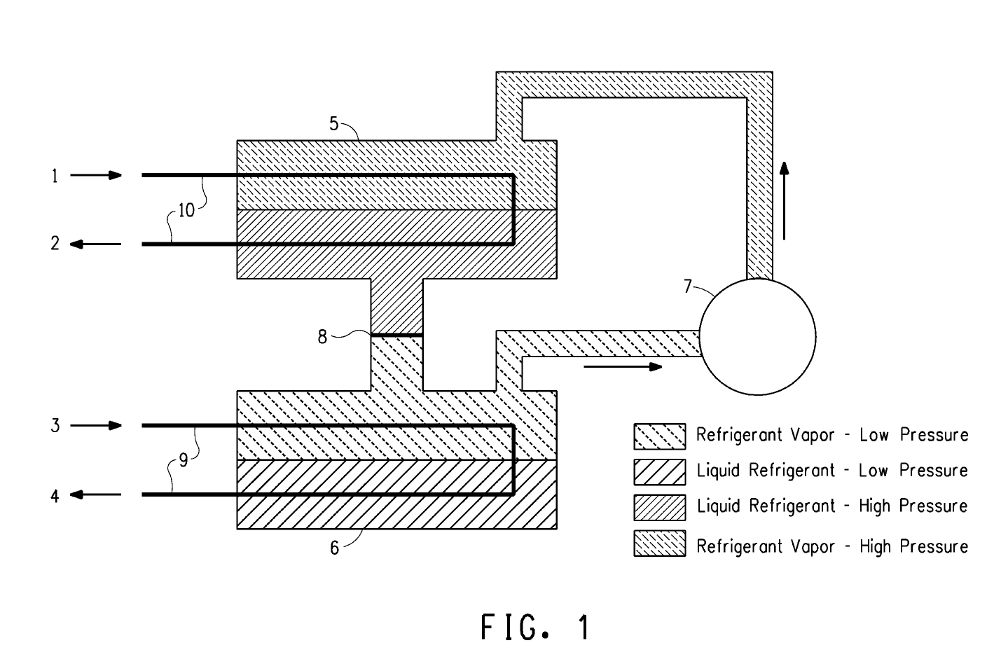

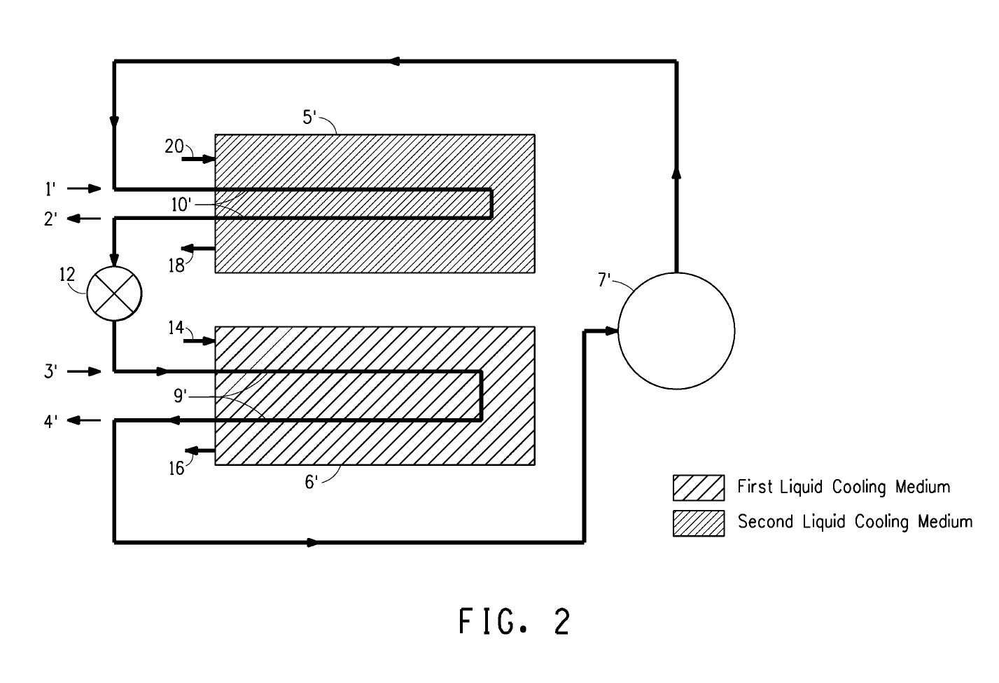

In one embodiment, the compositions of Group A and of Group B may be used as refrigerants in a chiller. A chiller is a type of air conditioning/refrigeration apparatus. Two types of water chillers are available, vapor-compression chillers and absorption chillers. The present disclosure is directed to a vapor compression chiller. Such vapor compression chiller may be either a flooded evaporator chiller, which is shown in FIG. 1, or a direct expansion chiller, which is shown in FIG. 2. Both a flooded evaporator chiller and a direct expansion chiller may be air-cooled or water-cooled. In the embodiment where chillers are water cooled, such chillers are generally associated with cooling towers for heat rejection from the system. In the embodiment where chillers are air-cooled, the chillers are equipped with refrigerant-to-air finned-tube condenser coils and fans to reject heat from the system. Air-cooled chiller systems are generally less costly than equivalent-capacity water-cooled chiller systems including cooling tower and water pump. However, water-cooled systems can be more efficient under many operating conditions due to lower condensing temperatures.

Chillers, including both flooded evaporator and direct expansion chillers, may be coupled with an air handling and distribution system to provide comfort air conditioning (cooling and dehumidifying the air) to large commercial buildings, including hotels, office buildings, hospitals, universities and the like. In another embodiment, chillers, most likely air-cooled direct expansion chillers, have found additional utility in naval submarines and surface vessels.

To illustrate how chillers operate, reference is made to the Figures. A water-cooled, flooded evaporator chiller is shown illustrated in FIG. 1. In this chiller a first cooling medium, which is a warm liquid, which may be water, and, in some embodiments, additives, such as glycol, enters the chiller from a cooling system, such as a building cooling system, shown entering at arrow 3, through an evaporator coil 9. The first cooling medium is chilled in the evaporator by liquid refrigerant, which is shown in the lower portion of the evaporator. The liquid refrigerant evaporates at a lower temperature than the warm cooling medium which flows through coil 9. The chilled cooling medium re-circulates back to the building cooling system, as shown by arrow 4, via a return portion of coil 9. The liquid refrigerant, shown in the lower portion of evaporator 6 in FIG. 1, vaporizes and is drawn into a compressor 7, which increases the pressure and temperature of the refrigerant vapor. The compressor compresses this vapor so that it may be condensed in a condenser 5 at a higher temperature than the temperature of the refrigerant vapor when it comes out of the evaporator. A second cooling medium, which is a liquid in the case of a water-cooled chiller, enters the condenser via a condenser coil 10 from a cooling tower at arrow 1 in FIG. 1. The second cooling medium is warmed in the process and returned via a return loop of coil 10 and arrow 2 to a cooling tower or to the environment. This second cooling medium cools the vapor in the condenser and turns the vapor to liquid refrigerant, so that there is liquid refrigerant in the lower portion of the condenser as shown in FIG. 1. The condensed liquid refrigerant in the condenser flows back to the evaporator through an expansion device or an orifice 8. Orifice 8 reduces the pressure of the liquid refrigerant, and converts the liquid refrigerant partially to vapor, that is to say that the liquid refrigerant flashes as pressure drops between the condenser and the evaporator. Flashing cools the refrigerant, i.e., both the liquid refrigerant and the refrigerant vapor to the saturated temperature at evaporator pressure, so that both liquid refrigerant and refrigerant vapor are present in the evaporator.

It should be noted that for a single component refrigerant composition, the composition of the vapor refrigerant in the evaporator is the same as the composition of the liquid refrigerant in the evaporator. In this case, evaporation will occur at a constant temperature. However, if a refrigerant blend is used, as in the case of the compositions of the present invention, the liquid refrigerant and the refrigerant vapor in the evaporator (or in the condenser) may have different compositions. Such compositions depend on the properties of the components such as boiling points, chemical structures and ability to form azeotropes, etc.

Chillers with capacities above 700 kW generally employ flooded evaporators, where the refrigerant is contained in the evaporator and the condenser (i.e., on the shell side). Flooded evaporators require higher charges of refrigerant, but permit closer approach temperatures and higher efficiencies. Chillers with capacities below 700 kW commonly employ evaporators with refrigerant flowing inside the tubes and chilled cooling medium in the evaporator and the condenser, i.e., on the shell side. Such chillers are called direct-expansion (DX) chillers. A water-cooled direct expansion chiller is illustrated in FIG. 2. In the chiller as illustrated in FIG. 2, first liquid cooling medium, such as warm water, enters an evaporator 6′ at inlet 14. Mostly liquid refrigerant (with a small amount of refrigerant vapor) enters an evaporator coil 9′ at arrow 3′ and evaporates, turning to vapor. As a result, cooling of the first liquid cooling medium is produced, and this cooling medium exits the evaporator at outlet 16. The refrigerant vapor exits the evaporator at arrow 4′ and is sent to a compressor 7′, where it is compressed and exits as high temperature, high pressure refrigerant vapor. This refrigerant vapor enters a condenser 5′ through a condenser coil 10′ at 1′. The refrigerant vapor is cooled by a second liquid cooling medium, such as water, in the condenser and becomes a liquid. The second liquid cooling medium, enters the condenser through a condenser water inlet 20, The second liquid cooling medium extracts heat from the condensed refrigerant vapor, which becomes liquid refrigerant, and this heats the second liquid cooling medium in the condenser. The second liquid cooling medium exits through the condenser through outlet 18. The condensed refrigerant liquid exits the condenser through lower coil 10′ as shown in FIG. 2 and flows through an expansion valve 12, which reduces the pressure of the liquid refrigerant. A small amount of vapor, produced as a result of the expansion, enters the evaporator with liquid refrigerant through coil 9′ and the cycle repeats.

Vapor-compression chillers are identified by the type of compressor they employ. In one embodiment, the compositions of Group A and of Group B are useful in centrifugal chillers, which utilize centrifugal compressors, as will be described below. In another embodiment the compositions of Group A and of Group B are useful in positive displacement chillers, which utilize positive displacement compressors, either reciprocating, screw, or scroll compressors.

A centrifugal compressor uses rotating elements to accelerate the refrigerant radially, and typically includes an impeller and diffuser housed in a casing. Centrifugal compressors usually take fluid in at an impeller eye, or central inlet of a circulating impeller, and accelerate it radially outward. Some static pressure rise occurs in the impeller, but most of the pressure rise occurs in the diffuser section of the casing, where velocity is converted to static pressure. Each impeller-diffuser set is a stage of the compressor. Centrifugal compressors are built with from 1 to 12 or more stages, depending on the final pressure desired and the volume of refrigerant to be handled.

The pressure ratio, or compression ratio, of a compressor is the ratio of absolute discharge pressure to the absolute inlet pressure. Pressure delivered by a centrifugal compressor is practically constant over a relatively wide range of capacities. The pressure a centrifugal compressor can develop depends on the tip speed of the impeller. Tip speed is the speed of the impeller measured at its tip and is related to the diameter of the impeller and its revolutions per minute. The capacity of the centrifugal compressor is determined by the size of the passages through the impeller. This makes the size of the compressor more dependent on the pressure required than the capacity.

Positive displacement compressors draw vapor into a chamber, and the chamber decreases in volume to compress the vapor. After being compressed, the vapor is forced from the chamber by further decreasing the volume of the chamber to zero or nearly zero.

Reciprocating compressors use pistons driven by a crankshaft. They can be either stationary or portable, can be single or multi-staged, and can be driven by electric motors or internal combustion engines. Small reciprocating compressors from 5 to 30 hp are seen in automotive applications and are typically for intermittent duty. Larger reciprocating compressors up to 100 hp are found in large industrial applications. Discharge pressures can range from low pressure to very high pressure (>5000 psi or 35 MPa).

Screw compressors use two meshed rotating positive-displacement helical screws to force the gas into a smaller space. Screw compressors are usually for continuous operation in commercial and industrial application and may be either stationary or portable. Their application can be from 5 hp (3.7 kW) to over 500 hp (375 kW) and from low pressure to very high pressure (>1200 psi or 8.3 MPa).

Scroll compressors are similar to screw compressors and include two interleaved spiral-shaped scrolls to compress the gas. The output is more pulsed than that of a rotary screw compressor.

For chillers which use scroll compressors or reciprocating compressors, capacities below 150 kW, brazed-plate heat exchangers are commonly used for evaporators instead of the shell-and-tube heat exchangers employed in larger chillers. Brazed-plate heat exchangers reduce system volume and refrigerant charge.

### Other Air Conditioning/Refrigeration Systems

The compositions of Group A and of Group B may also be useful in other air conditioning/refrigeration systems, such as small coolers which have less than 5 to 10 kW cooling capacity, or in closed loop heat transfer systems, which re-use refrigerant in multiple steps to produce a cooling effect in one step and a heating effect in a different step. Such systems are typically used in mobile air conditioning systems. As used herein, a mobile air conditioning system refers to any refrigeration or air-conditioning apparatus incorporated into a transportation unit for the road, rail, sea or air.

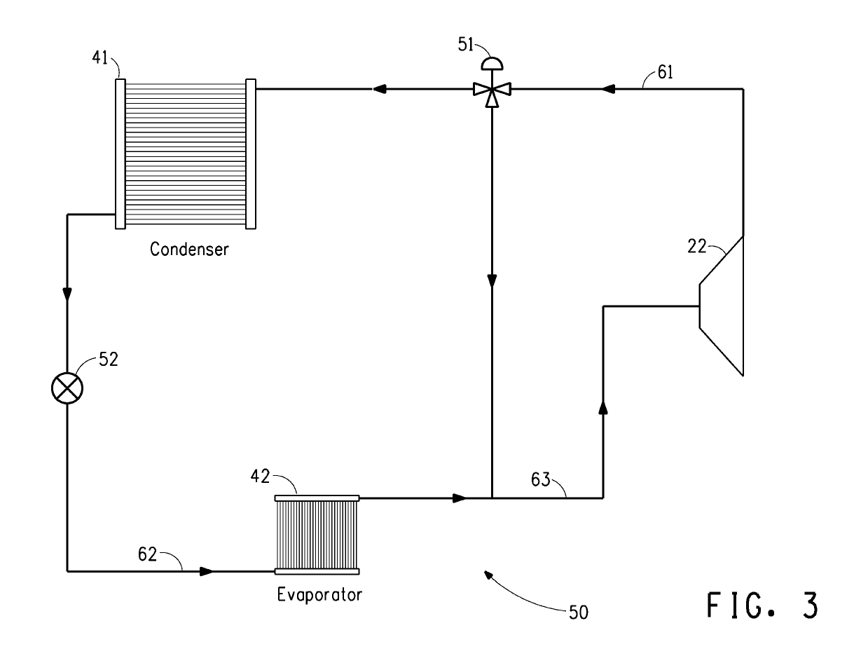

A closed loop heat transfer system, which may be used as a mobile air conditioning system, is shown generally at 50 in FIG. 3. With reference to FIG. 3, the system includes a compressor 22 having an inlet and an outlet. A gaseous refrigerant composition flows from the outlet of an evaporator 42, having an inlet and an outlet, through a connecting line 63 to the inlet of the compressor, where the gaseous refrigerant is compressed to a higher pressure. Various types of compressors may be used with the present invention, including reciprocating, rotary, jet, centrifugal, scroll, screw or axial-flow, depending on the mechanical means to compress the fluid, or as positive-displacement (e.g., reciprocating, scroll or screw) or dynamic (e.g., centrifugal or jet). The compressed, gaseous refrigerant composition from the compressor flows through the compressor outlet and through a connecting line 61 to a condenser 41. A pressure regulating valve 51 in connecting line 61 may be used. This valve allows recycle of the refrigerant flow back to the compressor via a connecting line 63, thereby providing the ability to control the pressure of the refrigerant composition reaching the condenser 41 and if necessary to prevent compressor surge. The compressed gaseous refrigerant composition is condensed in the condenser, thus giving off heat, and is converted to a liquid. The outlet of the condenser is connected to the inlet of an expander 52. The liquid refrigerant composition flows through expander 52 and expands. The expander 52 may be an expansion valve, a capillary tube or an orifice tube, or any other device where the heat transfer composition may undergo an abrupt reduction in pressure. The outlet of the expander is connected via a connecting line 62 to an evaporator 42, which is located in the passenger compartment. The liquid refrigerant composition boils in the evaporator at a low temperature to form a low pressure gas and thus produces cooling. The outlet of the evaporator is connected to the inlet of the compressor. The low-pressure gas from the evaporator enters the compressor, where the gas is compressed to raise its pressure and temperature, and the cycle repeats.

### Methods

According to another aspect of the present invention, the compositions of Group A and of Group B are useful in methods to produce cooling. In these methods, the compositions of Group A and of Group B are refrigerants.

In one embodiment, the method for producing cooling comprises producing cooling in a flooded evaporator chiller as described above with respect to FIG. 1. In this method, a composition of Group A or Group B is evaporated to form a vapor refrigerant in the vicinity of a first cooling medium. The cooling medium is a warm liquid, such as water, which is transported into the evaporator via a pipe from a cooling system. The warm liquid is cooled and is passed to a body to be cooled, such as a building. The composition is then condensed in the vicinity of a second cooling medium, which is a chilled liquid which is brought in from a cooling tower. The second cooling medium cools the vapor refrigerant to a liquid refrigerant. In this method, a flooded evaporator chiller may also be used to cool hotels, office buildings, hospitals and universities.

In another embodiment, the method for producing cooling comprises producing cooling in a direct expansion chiller as described above with respect to FIG. 2. In this method, a refrigerant composition of Group A or Group B is passed through an evaporator. A first liquid cooling medium is evaporated in the evaporator to form a cooling medium vapor, thereby cooling the composition. The composition is passed out of the evaporator to a body to be cooled. In this method, the direct expansion chiller may also be used to cool hotels, office buildings, hospitals, universities, as well as naval submarines or naval surface vessels.

In another embodiment, the method for producing cooling comprises producing cooling in a closed loop heat transfer system as described above with respect to FIG. 3. This method comprises the steps of evaporating a refrigerant composition of Group B in the vicinity of a body to be cooled. The refrigerant composition is thereafter condensed.

A high GWP refrigerant is any compound capable of functioning as a refrigerant or heat transfer fluid having a GWP at the 100 year time horizon of about 1000 or greater. The compositions of Group A and of Group B of the present invention have zero or low ozone depletion potential and low global warming potential (GWP). The compositions as disclosed herein have global warming potentials that are less than many hydrofluorocarbon refrigerants currently in use. Typically, fluoroolefins, such as HFC-1225ye, are expected to have GWP of less than about 25. One aspect of the present invention is to provide a refrigerant with a global warming potential of less than 1000, less than 500, less than 150, less than 100, or less than 50.

Refrigerants and heat transfer fluids that are in need of replacement, based upon GWP calculations published by the Intergovernmental Panel on Climate Change (IPCC), include but are not limited to HFC-134a. Therefore, in accordance with the present invention, there is provided a method for replacing HFC-134a in a flooded evaporator chiller, a direct expansion chiller or a closed loop heat transfer system. The method comprises providing a refrigerant composition comprising the compositions of Group A to a flooded evaporator chiller, direct expansion chiller or closed loop heat transfer system in place of HFC-134a, or the compositions of Group A or Group B to a flooded evaporator chiller or a direct expansion chiller.

In this method of replacing 134a, the compositions of either Group A or Group B are useful in centrifugal chillers that may have been originally designed and manufactured to operate with HFC-134a. In another embodiment, the compositions of Group A and Group B are useful in reciprocating chillers that may have been originally designed and manufactured to operate with HFC-134a. In another embodiment using either a positive displacement or scroll compressor, the compositions of Group A or Group B are useful in screw chillers that may have been originally designed and manufactured to operate with HFC-134a.

Alternatively, in this method of replacing 134a, the compositions of Group A or Group B disclosed herein may be useful in new equipment, such as a new flooded evaporator chiller, a new direct expansion chiller or a new closed loop heat transfer system. In such new equipment, either a centrifugal compressor or a positive displacement compressor, including reciprocating, screw or scroll compressors, and the heat exchangers used therewith, may be used.

### Example

### Cooling Performance Data

Table 3 shows cooling performance, as compressor suction pressure (Comp Suct Pres), compressor discharge pressure (Disch Pres), compressor discharge temperature (Disch Temp), energy efficiency (COP), capacity (Cap), and average glide (Avg Glide) for compositions described herein as compared to HFC-134a. The data are based on the following conditions.

| Evaporator temperature | 7° C. |
|---|---|
| Condenser temperature | 48° C. |
| Subcool temperature | 5° C. |
| Return gas temperature | 12° C. |
| Compressor efficiency is | 70% |

TABLE 3

| | | Comp | | | | COP | | Cap | |
|---|---|---|---|---|---|---|---|---|---|
| | | Suct | Disch | Disch | | relative | | relative | Avg |
| | | Pres | Pres | Temp | | to | Cap | to | Glide |
| Composition | Wt % | (kPa) | (kPa) | (° C.) | COP | R134a | (kJ/m³) | R134a | (° C.) |
| HFC-134a | 100 | 374 | 1254 | 67.3 | 2.77 | 100 | 2605 | 100.0 | 0.00 |
| HFC-1225ye | 100 | 284 | 966 | 58.5 | 2.77 | 99.8 | 1972 | 75.7 | 0.00 |
| HFC-1225ye/HFC-32 | 95/5 | 340 | 1169 | 63.1 | 2.75 | 99.3 | 2370 | 91.0 | 4.90 |
| HFC-1225ye/HFC-1234yf | 80/20 | 309 | 1032 | 58.9 | 2.75 | 99.4 | 2103 | 80.7 | 0.40 |
| | 60/40 | 333 | 1091 | 59.1 | 2.74 | 99.1 | 2221 | 85.3 | 0.51 |
| | 50/50 | 344 | 1119 | 59.2 | 2.74 | 98.9 | 2276 | 87.4 | 0.49 |
| HFC-1225ye/HFC-32 | 99/1 | 295 | 1009 | 59.5 | 2.76 | 99.6 | 2057 | 79.0 | 1.23 |
| | 98/2 | 307 | 1050 | 60.5 | 2.76 | 99.6 | 2139 | 82.1 | 2.31 |
| | 96/4 | 329 | 1130 | 62.3 | 2.75 | 99.3 | 2296 | 88.1 | 4.14 |
| | 92/8 | 372 | 1279 | 65.5 | 2.73 | 98.5 | 2585 | 99.2 | 6.74 |
| | 84/16 | 455 | 1541 | 70.9 | 2.69 | 97.3 | 3102 | 119.1 | 9.20 |
| HFC-1225ye/HFC-125 | 99/1 | 287 | 978 | 58.6 | 2.76 | 99.7 | 1994 | 76.5 | 0.28 |
| | 98/2 | 291 | 990 | 58.7 | 2.76 | 99.6 | 2017 | 77.4 | 0.54 |
| | 96/4 | 298 | 1015 | 58.9 | 2.75 | 99.4 | 2061 | 79.1 | 1.04 |
| | 92/8 | 313 | 1063 | 59.2 | 2.74 | 99.0 | 2148 | 82.5 | 1.95 |
| | 84/16 | 343 | 1162 | 59.8 | 2.71 | 98.0 | 2320 | 89.1 | 3.40 |
| HFC-1225ye/HFC-134a | 95/5 | 292 | 991 | 59.1 | 2.76 | 99.7 | 2024 | 77.7 | 0.21 |
| | 90/10 | 299 | 1015 | 59.6 | 2.76 | 99.7 | 2073 | 79.6 | 0.36 |
| | 80/20 | 313 | 1058 | 60.6 | 2.76 | 99.7 | 2163 | 83.0 | 0.50 |
| | 65/35 | 331 | 1112 | 62.0 | 2.76 | 99.7 | 2281 | 87.6 | 0.50 |
| | 50/50 | 345 | 1157 | 63.3 | 2.76 | 99.7 | 2380 | 91.4 | 0.38 |
| HFC-1225ye/HFC-152a | 99/1 | 285 | 970 | 58.8 | 2.77 | 99.9 | 1984 | 76.2 | 0.02 |
| | 98/2 | 287 | 974 | 59.1 | 2.77 | 99.9 | 1995 | 76.6 | 0.04 |
| | 96/4 | 289 | 982 | 59.7 | 2.77 | 100 | 2017 | 77.4 | 0.08 |
| | 92/8 | 294 | 996 | 60.8 | 2.78 | 100 | 2057 | 79.0 | 0.08 |
| HFC-1225ye/HFC-161 | 99/1 | 288 | 980 | 59.0 | 2.77 | 99.9 | 2004 | 76.9 | 0.16 |
| | 98/2 | 292 | 993 | 59.5 | 2.77 | 100 | 2034 | 78.1 | 0.52 |
| | 96/4 | 301 | 1018 | 60.5 | 2.77 | 100 | 2095 | 80.4 | 0.57 |
| | 92/8 | 317 | 1065 | 62.3 | 2.78 | 100 | 2208 | 84.8 | 1.02 |
| HFC-1225ye/HC-C270 | 99/1 | 297 | 1006 | 59.2 | 2.76 | 99.6 | 2052 | 78.8 | 1.06 |
| | 98/2 | 309 | 1042 | 59.8 | 2.76 | 99.5 | 2126 | 81.6 | 1.88 |
| | 96/4 | 332 | 1106 | 60.7 | 2.75 | 99.2 | 2255 | 86.6 | 3.00 |
| | 92/8 | 372 | 1207 | 62.3 | 2.74 | 98.8 | 2464 | 94.6 | 3.83 |
| HFC-1225ye/R717 | 99/1 | 313 | 1070 | 61.3 | 2.77 | 100 | 2194 | 84.2 | 2.46 |
| | 98/2 | 340 | 1162 | 63.8 | 2.77 | 100 | 2392 | 91.8 | 4.13 |
| | 96/4 | 387 | 1316 | 68.1 | 2.78 | 100 | 2738 | 105.1 | 5.99 |
| HFC-1225ye/HC-290 | 99/1 | 299 | 1017 | 59.1 | 2.75 | 99.4 | 2066 | 79.3 | 1.55 |
| | 98/2 | 314 | 1063 | 59.5 | 2.74 | 99.0 | 2151 | 82.6 | 2.78 |
| | 96/4 | 341 | 1146 | 60.2 | 2.72 | 98.2 | 2298 | 88.2 | 4.51 |
| HFC-1225ye/HC-1270 | 99/1 | 301 | 1025 | 59.3 | 2.75 | 99.4 | 2082 | 79.9 | 1.86 |
| | 98/2 | 317 | 1079 | 60.1 | 2.74 | 99.0 | 2181 | 83.7 | 3.34 |
| | 96/4 | 347 | 1176 | 61.3 | 2.71 | 98.% | 2354 | 90.4 | 5.49 |
| HFC-1225ye/HFC-134a/HFC- | 47.5/5/47.5 | 349 | 1135 | 59.6 | 2.74 | 98.9 | 2310 | 88.7 | 0.53 |
| 1234yf | | | | | | | | | |
| | 45/10/45 | 353 | 1150 | 60.1 | 2.74 | 98.9 | 2342 | 89.9 | 0.56 |
| | 40/20/40 | 361 | 1176 | 60.9 | 2.74 | 99.0 | 2397 | 92.0 | 0.54 |
| | 35/30/35 | 367 | 1198 | 61.7 | 2.74 | 99.0 | 2446 | 93.9 | 0.48 |
| | 30/40/30 | 372 | 1216 | 62.5 | 2.75 | 99.1 | 2487 | 95.5 | 0.40 |
| | 25/50/25 | 375 | 1230 | 63.3 | 2.75 | 99.2 | 2522 | 96.8 | 0.31 |
| HFC-1225ye/HFC-134a/HFC- | 94/5/1 | 303 | 1032 | 60.0 | 2.76 | 99.6 | 2107 | 80.9 | 1.32 |
| 32 | | | | | | | | | |
| | 93/5/2 | 314 | 1072 | 60.9 | 2.76 | 99.6 | 2186 | 83.9 | 2.31 |
| | 91/5/4 | 336 | 1149 | 62.6 | 2.75 | 99.3 | 2338 | 89.8 | 3.98 |
| | 87/5/8 | 378 | 1293 | 65.8 | 2.73 | 98.6 | 2619 | 100.5 | 6.40 |
| | 89/10/1 | 310 | 1054 | 60.5 | 2.76 | 99.6 | 2153 | 82.6 | 1.37 |
| | 88/10/2 | 321 | 1093 | 61.4 | 2.76 | 99.6 | 2230 | 85.6 | 2.27 |
| | 86/10/4 | 342 | 1168 | 63.0 | 2.75 | 99.3 | 2377 | 91.2 | 3.81 |
| | 82/10/8 | 383 | 1308 | 66.1 | 2.73 | 98.7 | 2652 | 101.8 | 6.36 |
| | 79/20/1 | 323 | 1094 | 61.4 | 2.76 | 99.6 | 2238 | 85.9 | 1.35 |
| | 78/20/2 | 334 | 1130 | 62.2 | 2.76 | 99.5 | 2311 | 88.7 | 2.12 |
| | 76/20/4 | 354 | 1200 | 63.8 | 2.75 | 99.3 | 2451 | 94.1 | 3.43 |
| | 72/20/8 | 394 | 1332 | 66.7 | 2.74 | 98.8 | 2713 | 104.1 | 5.32 |
| | 64/35/1 | 340 | 1146 | 62.7 | 2.76 | 99.6 | 2349 | 90.2 | 1.17 |
| | 63/35/2 | 350 | 1179 | 63.5 | 2.76 | 99.6 | 2416 | 92.7 | 1.79 |
| | 61/35/4 | 369 | 1242 | 64.9 | 2.75 | 99.4 | 2546 | 97.7 | 2.85 |
| | 57/35/8 | 406 | 1363 | 67.7 | 2.74 | 99.0 | 2790 | 107.1 | 4.41 |
| | 49/50/1 | 354 | 1188 | 64.0 | 2.76 | 99.7 | 2443 | 93.8 | 0.93 |
| | 48/50/2 | 363 | 1218 | 64.7 | 2.76 | 99.6 | 2505 | 96.2 | 1.43 |
| | 46/50/4 | 381 | 1276 | 65.1 | 2.76 | 99.5 | 2625 | 100.8 | 2.33 |
| | 42/50/8 | 415 | 1387 | 68.6 | 2.75 | 99.1 | 2853 | 109.5 | 3.66 |
| HFC-1225ye/HFC-134a/HFC- | 94/5/1 | 295 | 1003 | 59.1 | 2.76 | 99.6 | 2046 | 78.5 | 0.46 |
| 125 | | | | | | | | | |
| | 93/5/2 | 299 | 1015 | 59.2 | 2.76 | 99.5 | 2068 | 79.4 | 0.70 |
| | 91/5/4 | 306 | 1039 | 59.4 | 2.75 | 99.4 | 2111 | 81.0 | 1.16 |
| | 87/5/8 | 321 | 1089 | 59.7 | 2.74 | 98.9 | 2197 | 84.3 | 1.98 |
| | 79/5/16 | 351 | 1184 | 60.3 | 2.71 | 98.0 | 2366 | 90.8 | 3.30 |
| | 89/10/1 | 303 | 1027 | 59.7 | 2.76 | 99.6 | 2095 | 80.4 | 0.59 |
| | 88/10/2 | 306 | 1038 | 59.8 | 2.76 | 99.5 | 2116 | 81.2 | 0.80 |
| | 86/10/4 | 313 | 1062 | 59.9 | 2.75 | 99.3 | 2158 | 82.8 | 1.22 |
| | 82/10/8 | 328 | 1109 | 60.2 | 2.74 | 98.9 | 2243 | 86.1 | 1.98 |
| | 74/10/16 | 358 | 1205 | 60.7 | 2.71 | 98.0 | 2409 | 92.5 | 3.18 |
| | 79/20/1 | 316 | 1069 | 60.7 | 2.76 | 99.6 | 2184 | 83.8 | 0.70 |
| | 78/20/2 | 320 | 1080 | 60.7 | 2.76 | 99.5 | 2205 | 84.6 | 0.88 |
| | 76/20/4 | 327 | 1103 | 60.9 | 2.75 | 99.3 | 2246 | 86.2 | 1.24 |
| | 72/20/8 | 341 | 1149 | 61.1 | 2.74 | 98.9 | 2327 | 89.3 | 1.87 |
| | 64/35/1 | 334 | 1123 | 62.0 | 2.76 | 99.6 | 2300 | 88.3 | 0.65 |
| | 63/35/2 | 337 | 1134 | 62.1 | 2.76 | 99.5 | 2320 | 89.1 | 0.81 |
| | 61/35/4 | 344 | 1156 | 62.2 | 2.78 | 100 | 2359 | 90.6 | 1.09 |
| | 49/50/1 | 348 | 1168 | 63.3 | 2.76 | 99.6 | 2398 | 92.1 | 0.51 |
| HFC-1225ye/HFC-134a/HFC- | 94/5/1 | 293 | 995 | 59.4 | 2.77 | 99.8 | 2035 | 78.1 | 0.22 |
| 152a | | | | | | | | | |
| | 93/5/2 | 294 | 998 | 59.7 | 2.77 | 99.9 | 2045 | 78.5 | 0.22 |
| | 91/5/4 | 296 | 1005 | 60.2 | 2.77 | 100 | 2064 | 79.2 | 0.23 |
| | 87/5/8 | 301 | 1016 | 61.3 | 2.78 | 100 | 2101 | 80.7 | 0.24 |
| | 89/10/1 | 300 | 1018 | 59.9 | 2.76 | 99.8 | 2083 | 80.0 | 0.35 |
| | 88/10/2 | 301 | 1021 | 60.1 | 2.77 | 99.9 | 2092 | 80.3 | 0.35 |
| | 86/10/4 | 303 | 1026 | 60.7 | 2.77 | 100 | 2110 | 81.0 | 0.34 |
| | 82/10/8 | 307 | 1036 | 61.8 | 2.78 | 100 | 2143 | 82.3 | 0.32 |
| | 79/20/1 | 314 | 1060 | 60.9 | 2.76 | 99.8 | 2171 | 83.3 | 0.49 |
| | 78/20/2 | 314 | 1062 | 61.1 | 2.77 | 99.9 | 2178 | 83.6 | 0.47 |
| | 76/20/4 | 316 | 1065 | 61.7 | 2.77 | 100 | 2193 | 84.2 | 0.44 |
| | 72/20/8 | 318 | 1072 | 62.7 | 2.78 | 100 | 2220 | 85.2 | 0.39 |
| | 64/35/1 | 331 | 1113 | 62.2 | 2.76 | 99.8 | 2286 | 87.8 | 0.48 |
| | 63/35/2 | 331 | 1114 | 62.5 | 2.77 | 99.9 | 2291 | 87.9 | 0.46 |
| | 61/35/4 | 332 | 1115 | 63.0 | 2.77 | 100 | 2301 | 88.3 | 0.42 |
| | 57/35/8 | 333 | 1118 | 64.0 | 2.78 | 100 | 2320 | 89.1 | 0.36 |
| | 49/50/1 | 345 | 1157 | 63.5 | 2.77 | 99.8 | 2383 | 91.5 | 0.36 |
| | 48/50/2 | 345 | 1157 | 63.8 | 2.77 | 99.9 | 2386 | 91.6 | 0.35 |
| | 46/50/4 | 345 | 1157 | 64.3 | 2.77 | 100 | 2393 | 91.9 | 0.32 |
| | 42/50/8 | 345 | 1156 | 65.2 | 2.78 | 100 | 2405 | 92.3 | 0.27 |
| HFC-1225ye/HFC-134a/HFC- | 94/5/1 | 296 | 1004 | 59.6 | 2.77 | 99.8 | 2054 | 78.8 | 0.34 |
| 161 | | | | | | | | | |
| | 93/5/2 | 300 | 1016 | 60.1 | 2.77 | 99.9 | 2084 | 80.0 | 0.46 |
| | 91/5/4 | 308 | 1040 | 61.0 | 2.77 | 100 | 2142 | 82.2 | 0.68 |
| | 87/5/8 | 324 | 1086 | 62.8 | 2.78 | 100 | 2251 | 86.4 | 1.06 |
| | 89/10/1 | 303 | 1027 | 60.1 | 2.77 | 99.8 | 2102 | 80.7 | 0.46 |
| | 88/10/2 | 307 | 1038 | 60.6 | 2.77 | 99.9 | 2131 | 81.8 | 0.56 |
| | 86/10/4 | 315 | 1061 | 61.5 | 2.77 | 100 | 2186 | 83.9 | 0.74 |
| | 82/10/8 | 330 | 1105 | 63.2 | 2.78 | 100 | 2291 | 87.9 | 1.06 |
| | 79/20/1 | 317 | 1068 | 61.0 | 2.76 | 99.8 | 2190 | 84.1 | 0.57 |
| | 78/20/2 | 320 | 1079 | 61.5 | 2.77 | 99.9 | 2216 | 85.1 | 0.64 |
| | 76/20/4 | 327 | 1100 | 62.4 | 2.77 | 100 | 2268 | 87.1 | 0.77 |
| | 72/20/8 | 341 | 1139 | 64.0 | 2.78 | 100 | 2365 | 90.8 | 0.98 |
| | 64/35/1 | 334 | 1122 | 62.4 | 2.76 | 99.8 | 2305 | 88.5 | 0.54 |
| | 63/35/2 | 337 | 1131 | 62.8 | 2.77 | 99.9 | 2328 | 89.4 | 0.58 |
| | 61/35/4 | 344 | 1149 | 63.6 | 2.77 | 100 | 2374 | 91.1 | 0.66 |
| | 57/35/8 | 356 | 1184 | 65.2 | 2.78 | 100 | 2462 | 94.5 | 0.80 |
| | 49/50/1 | 348 | 1166 | 63.7 | 2.77 | 99.8 | 2401 | 92.2 | 0.40 |
| | 48/50/2 | 351 | 1174 | 64.1 | 2.77 | 99.9 | 2423 | 93.0 | 0.43 |
| | 46/50/4 | 357 | 1190 | 64.8 | 2.77 | 100 | 2464 | 94.6 | 0.49 |
| | 42/50/8 | 368 | 1221 | 66.3 | 2.78 | 100 | 2545 | 97.7 | 0.58 |
| HFC-1225ye/HFC-134a/HC- | 94/5/1 | 305 | 1030 | 59.7 | 2.76 | 99.6 | 2103 | 80.7 | 1.20 |
| C270 | | | | | | | | | |
| | 93/5/2 | 317 | 1066 | 60.3 | 2.75 | 99.4 | 2175 | 83.5 | 1.98 |
| | 91/5/4 | 340 | 1129 | 61.2 | 2.76 | 99.5 | 2303 | 88.4 | 3.03 |
| | 87/5/8 | 379 | 1229 | 62.7 | 2.73 | 98.7 | 2509 | 96.3 | 3.80 |
| | 89/10/1 | 312 | 1053 | 60.2 | 2.76 | 99.6 | 2151 | 82.6 | 1.29 |
| | 88/10/2 | 324 | 1089 | 60.7 | 2.75 | 99.4 | 2221 | 85.3 | 2.02 |
| | 86/10/4 | 347 | 1151 | 61.7 | 2.75 | 99.1 | 2347 | 90.1 | 3.02 |
| | 82/10/8 | 386 | 1250 | 63.1 | 2.73 | 98.7 | 2551 | 97.9 | 3.74 |
| | 79/20/1 | 325 | 1095 | 61.1 | 2.76 | 99.5 | 2238 | 85.9 | 1.34 |
| | 78/20/2 | 338 | 1129 | 61.6 | 2.75 | 99.4 | 2307 | 88.6 | 2.01 |
| | 76/20/4 | 360 | 1190 | 62.5 | 2.74 | 99.1 | 2430 | 93.3 | 2.92 |
| | 72/20/8 | 399 | 1287 | 63.9 | 2.73 | 98.6 | 2629 | 100.9 | 3.57 |
| | 64/35/1 | 343 | 1148 | 62.5 | 2.76 | 99.5 | 2353 | 90.3 | 1.25 |
| | 63/35/2 | 355 | 1181 | 62.9 | 2.75 | 99.4 | 2419 | 92.9 | 1.85 |
| | 61/35/4 | 377 | 1241 | 63.7 | 2.74 | 99.1 | 2538 | 97.4 | 2.66 |
| | 57/35/8 | 415 | 1335 | 65.0 | 2.73 | 98.6 | 2731 | 104.8 | 3.24 |
| | 49/50/1 | 357 | 1192 | 63.7 | 2.76 | 99.6 | 2449 | 94.0 | 1.06 |
| | 48/50/2 | 369 | 1224 | 64.2 | 2.75 | 99.4 | 2514 | 96.5 | 1.61 |
| | 46/50/4 | 391 | 1282 | 64.9 | 2.75 | 99.1 | 2629 | 100.9 | 2.37 |
| | 42/50/8 | 429 | 1375 | 66.1 | 2.73 | 98.6 | 2818 | 108.2 | 2.94 |
| HFC-1225ye/HFC-134a/R717 | 94/5/1 | 320 | 1090 | 61.8 | 2.77 | 100 | 2237 | 85.9 | 2.41 |
| | 93/5/2 | 346 | 1178 | 64.2 | 2.77 | 100 | 2429 | 93.2 | 3.92 |
| | 91/5/4 | 392 | 1327 | 68.4 | 2.78 | 100 | 2764 | 106.1 | 5.64 |
| | 89/10/1 | 327 | 1111 | 62.2 | 2.77 | 99.9 | 2281 | 87.6 | 2.38 |
| | 88/10/2 | 352 | 1196 | 64.6 | 2.77 | 100 | 2467 | 94.7 | 3.78 |
| | 86/10/4 | 397 | 1341 | 68.7 | 2.78 | 100 | 2795 | 107.3 | 5.37 |
| | 79/20/1 | 339 | 1148 | 63.1 | 2.77 | 99.9 | 2361 | 90.6 | 2.23 |
| | 78/20/2 | 363 | 1229 | 65.3 | 2.77 | 100 | 2539 | 97.5 | 3.45 |
| | 76/20/4 | 406 | 1366 | 69.3 | 2.78 | 100 | 2852 | 109.5 | 4.83 |
| | 64/35/1 | 355 | 1196 | 64.3 | 2.77 | 99.9 | 2465 | 94.6 | 1.91 |
| | 63/35/2 | 378 | 1270 | 66.4 | 2.77 | 100 | 2631 | 101.0 | 2.92 |
| | 61/35/4 | 418 | 1398 | 70.2 | 2.78 | 100 | 2925 | 112.3 | 4.10 |
| | 49/50/1 | 368 | 1234 | 65.4 | 2.77 | 99.9 | 2552 | 98.0 | 1.57 |
| | 48/50/2 | 389 | 1303 | 67.4 | 2.77 | 100 | 2707 | 103.9 | 2.44 |
| | 46/50/4 | 427 | 1423 | 71.1 | 2.78 | 100 | 2985 | 114.6 | 3.49 |
| HFC-1225ye/HFC-134a/HC- | 94/5/1 | 307 | 1042 | 59.6 | 2.75 | 99.4 | 2118 | 81.3 | 1.73 |
| 290 | | | | | | | | | |
| | 93/5/2 | 322 | 1089 | 60.1 | 2.74 | 98.9 | 2203 | 84.6 | 2.93 |
| | 91/5/4 | 349 | 1172 | 60.7 | 2.72 | 98.1 | 2350 | 90.2 | 4.62 |
| | 89/10/1 | 315 | 1066 | 60.1 | 2.75 | 99.3 | 2167 | 83.2 | 1.84 |
| | 88/10/2 | 329 | 1113 | 60.5 | 2.74 | 98.9 | 2252 | 86.4 | 3.03 |
| | 86/10/4 | 357 | 1197 | 61.2 | 2.72 | 98.0 | 2399 | 92.1 | 4.69 |
| | 79/20/1 | 329 | 1109 | 61.1 | 2.75 | 99.3 | 2258 | 86.7 | 1.95 |
| | 78/20/2 | 344 | 1157 | 61.5 | 2.74 | 98.8 | 2343 | 89.9 | 3.09 |
| | 76/20/4 | 372 | 1242 | 62.1 | 2.71 | 97.9 | 2491 | 95.6 | 4.73 |
| | 64/35/1 | 347 | 1165 | 62.4 | 2.75 | 99.3 | 2376 | 91.2 | 1.90 |
| | 63/35/2 | 362 | 1213 | 62.8 | 2.74 | 98.8 | 2462 | 94.5 | 3.03 |
| | 61/35/4 | 391 | 1300 | 63.4 | 2.71 | 97.9 | 2612 | 100.3 | 4.65 |
| | 49/50/1 | 362 | 1210 | 63.7 | 2.75 | 99.3 | 2477 | 95.1 | 1.76 |
| | 48/50/2 | 377 | 1259 | 64.1 | 2.74 | 98.8 | 2563 | 98.4 | 2.89 |
| | 46/50/4 | 407 | 1348 | 64.6 | 2.71 | 97.9 | 2715 | 104.2 | 4.51 |
| HFC-1225ye/HFC-134a/HC- | 94/5/1 | 309 | 1050 | 59.9 | 2.75 | 99.4 | 2133 | 81.9 | 2.01 |
| 1270 | | | | | | | | | |
| | 93/5/2 | 325 | 1104 | 60.6 | 2.74 | 98.9 | 2232 | 85.7 | 3.46 |
| | 91/5/4 | 356 | 1202 | 61.7 | 2.71 | 97.9 | 2405 | 92.3 | 5.55 |
| | 89/10/1 | 316 | 1073 | 60.4 | 2.75 | 99.3 | 2182 | 83.8 | 2.11 |
| | 88/10/2 | 333 | 1128 | 61.1 | 2.74 | 98.8 | 2280 | 87.5 | 3.52 |
| | 86/10/4 | 364 | 1226 | 62.2 | 2.71 | 97.9 | 2453 | 94.2 | 5.57 |
| | 79/20/1 | 330 | 1116 | 61.3 | 2.75 | 99.3 | 2272 | 87.2 | 2.18 |
| | 78/20/2 | 347 | 1171 | 62.0 | 2.74 | 98.8 | 2370 | 91.0 | 3.54 |
| | 76/20/4 | 378 | 1269 | 63.1 | 2.71 | 97.8 | 2542 | 97.6 | 5.52 |
| | 64/35/1 | 348 | 1171 | 62.7 | 2.75 | 99.3 | 2389 | 91.7 | 2.10 |
| | 63/35/2 | 365 | 1226 | 63.3 | 2.74 | 98.8 | 2487 | 95.5 | 3.46 |
| | 61/35/4 | 397 | 1325 | 64.3 | 2.71 | 97.8 | 2660 | 102.1 | 5.34 |
| | 49/50/1 | 363 | 1216 | 63.9 | 2.75 | 99.3 | 2488 | 95.5 | 1.94 |
| | 48/50/2 | 380 | 1271 | 64.5 | 2.74 | 98.8 | 2586 | 99.3 | 3.27 |
| | 46/50/4 | 412 | 1370 | 65.4 | 2.71 | 97.8 | 2760 | 106.0 | 5.12 |
| HFC-1225ye/HFC-134a/HFC- | 93/5/1/1 | 325 | 1108 | 61.9 | 2.77 | 99.8 | 2270 | 87.1 | 2.82 |
| 125/R717 | | | | | | | | | |
| | 92/5/2/1 | 328 | 1118 | 61.9 | 2.76 | 99.7 | 2288 | 87.8 | 2.95 |
| | 90/5/4/1 | 335 | 1139 | 62.0 | 2.76 | 99.5 | 2325 | 89.3 | 3.22 |
| | 86/5/8/1 | 348 | 1181 | 62.2 | 2.75 | 99.1 | 2399 | 92.1 | 3.69 |
| | 78/5/16/1 | 376 | 1267 | 62.6 | 2.72 | 98.2 | 2547 | 97.8 | 4.41 |
| | 88/10/1/1 | 332 | 1128 | 62.3 | 2.77 | 99.8 | 2312 | 88.8 | 2.75 |
| | 87/10/2/1 | 335 | 1138 | 62.4 | 2.76 | 99.7 | 2331 | 89.5 | 2.88 |
| | 85/10/4/1 | 342 | 1159 | 62.5 | 2.76 | 99.5 | 2367 | 90.9 | 3.12 |
| | 81/10/8/1 | 355 | 1201 | 62.6 | 2.74 | 99.1 | 2440 | 93.7 | 3.54 |
| | 73/10/16/1 | 384 | 1285 | 62.9 | 2.72 | 98.2 | 2586 | 99.3 | 4.19 |
| | 78/20/1/1 | 344 | 1165 | 63.2 | 2.76 | 99.8 | 2391 | 91.8 | 2.55 |
| | 77/20/2/1 | 347 | 1175 | 63.2 | 2.76 | 99.7 | 2409 | 92.5 | 2.66 |
| | 75/20/4/1 | 354 | 1195 | 63.3 | 2.76 | 99.5 | 2444 | 93.8 | 2.86 |
| | 71/20/8/1 | 367 | 1235 | 63.4 | 2.74 | 99.1 | 2515 | 96.5 | 3.22 |
| | 63/35/1/1 | 360 | 1211 | 64.4 | 2.77 | 99.8 | 2493 | 95.7 | 2.18 |
| | 62/35/2/1 | 363 | 1221 | 64.4 | 2.78 | 100 | 2510 | 96.4 | 2.26 |
| | 60/35/4/1 | 369 | 1240 | 64.5 | 2.76 | 99.5 | 3544 | 136.0 | 2.42 |
| | 48/50/1/1 | 373 | 1249 | 65.5 | 2.77 | 99.8 | 2578 | 99.0 | 1.80 |
| | 92/5/1/2 | 352 | 1200 | 64.3 | 2.77 | 99.9 | 2469 | 94.8 | 4.39 |
| | 91/5/2/2 | 355 | 1210 | 64.3 | 2.77 | 99.8 | 2487 | 95.5 | 4.48 |
| | 89/5/4/2 | 362 | 1230 | 64.4 | 2.76 | 99.6 | 2521 | 96.8 | 4.64 |
| | 85/5/8/2 | 379 | 1269 | 64.5 | 2.75 | 99.2 | 2590 | 99.4 | 4.90 |
| | 77/5/16/2 | 403 | 1349 | 64.7 | 2.72 | 98.2 | 2725 | 104.6 | 5.24 |
| | 87/10/1/2 | 358 | 1218 | 64.7 | 2.77 | 99.9 | 2507 | 96.2 | 4.25 |
| | 86/10/2/2 | 361 | 1227 | 64.7 | 2.77 | 99.8 | 2524 | 96.9 | 4.29 |
| | 84/10/4/2 | 368 | 1247 | 64.8 | 2.76 | 99.6 | 2558 | 98.2 | 4.43 |
| | 80/10/8/2 | 381 | 1286 | 64.9 | 2.75 | 99.2 | 2626 | 100.8 | 4.67 |
| | 72/10/16/2 | 408 | 1364 | 65.0 | 2.72 | 98.3 | 2760 | 106.0 | 4.96 |
| | 77/20/1/2 | 369 | 1249 | 64.9 | 2.77 | 99.9 | 2577 | 98.9 | 3.82 |
| | 76/20/2/2 | 373 | 1259 | 65.4 | 2.76 | 99.8 | 2593 | 99.5 | 3.88 |
| | 74/20/4/2 | 379 | 1277 | 65.5 | 2.76 | 99.6 | 2626 | 100.8 | 4.00 |
| | 70/20/8/2 | 392 | 1315 | 65.6 | 2.75 | 99.2 | 2693 | 103.4 | 4.19 |
| | 62/35/1/2 | 384 | 1289 | 66.5 | 2.77 | 99.9 | 2667 | 102.4 | 3.24 |
| | 61/35/2/2 | 387 | 1298 | 66.5 | 2.77 | 99.8 | 2683 | 103.0 | 3.28 |
| | 59/35/4/2 | 393 | 1316 | 66.5 | 2.76 | 99.6 | 2714 | 104.2 | 3.38 |
| | 47/50/1/2 | 395 | 1321 | 67.5 | 2.77 | 100 | 2742 | 105.3 | 2.71 |
| HFC-1225ye/HFC-134a/HFC- | 93/5/1/1 | 308 | 1042 | 59.8 | 2.76 | 99.5% | 2124 | 81.5% | 1.42 |
| 125/HC-C270 | | | | | | | | | |
| | 92/5/2/1 | 312 | 1054 | 59.9 | 2.75 | 99.4% | 2145 | 82.3% | 1.61 |
| | 90/5/4/1 | 319 | 1078 | 60.0 | 2.75 | 99.2% | 2188 | 84.0% | 2.04 |
| | 86/5/8/1 | 334 | 1125 | 60.3 | 2.73 | 98.7% | 2272 | 87.2% | 2.77 |
| | 78/5/16/1 | 364 | 1222 | 60.8 | 2.71 | 97.7% | 2438 | 93.6% | 3.92 |
| | 88/10/1/1 | 315 | 1065 | 60.3 | 2.76 | 99.5% | 2171 | 83.3% | 1.49 |
| | 87/10/2/1 | 319 | 1077 | 60.3 | 2.75 | 99.4% | 2192 | 84.1% | 1.69 |
| | 85/10/4/1 | 326 | 1100 | 60.5 | 2.75 | 99.1% | 2234 | 85.8% | 2.06 |
| | 81/10/8/1 | 341 | 1147 | 60.8 | 2.73 | 98.7% | 2316 | 88.9% | 2.72 |
| | 73/10/16/1 | 371 | 1242 | 61.2 | 2.71 | 97.7% | 2480 | 95.2% | 3.77 |
| | 78/20/1/1 | 329 | 1106 | 61.2 | 2.75 | 99.4% | 2258 | 86.7% | 1.52 |
| | 77/20/2/1 | 332 | 1117 | 61.3 | 2.75 | 99.3% | 2279 | 87.5% | 1.68 |
| | 75/20/4/1 | 340 | 1140 | 61.4 | 2.75 | 99.1% | 2319 | 89.0% | 2.00 |
| | 71/20/8/1 | 354 | 1186 | 61.6 | 2.73 | 98.7% | 2399 | 92.1% | 2.56 |
| | 63/35/1/1 | 346 | 1159 | 62.5 | 2.75 | 99.4% | 2372 | 91.1% | 1.39 |
| | 62/35/2/1 | 350 | 1170 | 62.6 | 2.75 | 99.4% | 2391 | 91.8% | 1.52 |
| | 60/35/4/1 | 357 | 1191 | 62.7 | 2.75 | 99.1% | 2430 | 93.3% | 1.78 |
| | 48/50/1/1 | 361 | 1202 | 63.8 | 2.76 | 99.5% | 2468 | 94.7% | 1.18 |
| | 92/5/1/2 | 320 | 1078 | 60.3 | 2.75 | 99.3% | 2196 | 84.3% | 2.17 |
| | 91/5/2/2 | 324 | 1090 | 60.4 | 2.75 | 99.2% | 2216 | 85.1% | 2.37 |
| | 89/5/4/2 | 331 | 1113 | 60.5 | 2.74 | 98.9% | 2258 | 86.7% | 2.73 |
| | 85/5/8/2 | 346 | 1161 | 60.8 | 2.73 | 98.6% | 2340 | 89.8% | 3.38 |
| | 77/5/16/2 | 376 | 1257 | 61.0 | 2.70 | 97.5% | 2504 | 96.1% | 4.39 |
| | 87/10/1/2 | 328 | 1100 | 60.8 | 2.75 | 99.3% | 2242 | 86.1% | 2.21 |
| | 86/10/2/2 | 331 | 1112 | 60.8 | 2.75 | 99.2% | 2262 | 86.8% | 2.42 |
| | 84/10/4/2 | 338 | 1135 | 61.0 | 2.74 | 99.0% | 2303 | 88.4% | 2.71 |
| | 80/10/8/2 | 353 | 1182 | 61.3 | 2.73 | 98.6% | 2384 | 91.5% | 3.30 |
| | 72/10/16/2 | 383 | 1276 | 61.7 | 2.70 | 97.5% | 2546 | 97.7% | 4.21 |
| | 77/20/1/2 | 341 | 1140 | 61.7 | 2.75 | 99.3% | 2327 | 89.3% | 2.16 |
| | 76/20/2/2 | 345 | 1152 | 61.8 | 2.75 | 99.2% | 2347 | 90.1% | 2.31 |
| | 74/20/4/2 | 352 | 1178 | 61.9 | 2.74 | 99.0% | 2386 | 91.6% | 2.59 |
| | 70/20/8/2 | 366 | 1220 | 62.1 | 2.73 | 98.5% | 2465 | 94.6% | 3.09 |
| | 62/35/1/2 | 358 | 1192 | 63.0 | 2.75 | 99.3% | 2438 | 93.6% | 1.97 |
| | 61/35/2/2 | 361 | 1203 | 63.0 | 2.75 | 99.2% | 2457 | 94.3% | 2.09 |
| | 59/35/4/2 | 369 | 1224 | 63.1 | 2.74 | 99.0% | 2495 | 95.8% | 2.33 |
| | 47/50/1/2 | 372 | 1235 | 64.2 | 2.75 | 99.3% | 2532 | 97.2% | 1.72 |
| HFC-1225ye/HFC-134a/HFC- | 93/5/1/1 | 311 | 1054 | 59.7 | 2.75 | 99.2 | 2140 | 82.1 | 1.95 |
| 125/HC-290 | | | | | | | | | |
| | 92/5/2/1 | 314 | 1066 | 59.8 | 2.75 | 99.1 | 2161 | 83.0 | 2.16 |
| | 90/5/4/1 | 322 | 1090 | 59.9 | 2.74 | 98.9 | 2203 | 84.6 | 2.56 |
| | 86/5/8/1 | 336 | 1139 | 60.2 | 2.73 | 98.4 | 2287 | 87.8 | 3.29 |
| | 78/5/16/1 | 365 | 1237 | 60.9 | 2.69 | 97.0 | 2443 | 93.8 | 4.42 |
| | 88/10/1/1 | 318 | 1078 | 60.2 | 2.75 | 99.2 | 2188 | 84.0 | 2.04 |
| | 87/10/2/1 | 322 | 1089 | 60.3 | 2.75 | 99.1 | 2209 | 84.8 | 2.24 |
| | 85/10/4/1 | 329 | 1113 | 60.4 | 2.74 | 98.9 | 2251 | 86.4 | 2.60 |
| | 81/10/8/1 | 344 | 1161 | 60.7 | 2.73 | 98.4 | 2333 | 89.6 | 3.26 |
| | 73/10/16/1 | 372 | 1258 | 61.4 | 2.69 | 96.9 | 2485 | 95.4 | 4.29 |
| | 78/20/1/1 | 332 | 1121 | 61.1 | 2.75 | 99.2 | 2278 | 87.4 | 2.12 |
| | 77/20/2/1 | 336 | 1132 | 61.2 | 2.74 | 99.1 | 2298 | 88.2 | 2.28 |
| | 75/20/4/1 | 343 | 1155 | 61.3 | 2.74 | 98.8 | 2238 | 85.9 | 2.58 |
| | 71/20/8/1 | 357 | 1201 | 61.6 | 2.73 | 98.4 | 2418 | 92.8 | 3.14 |
| | 63/35/1/1 | 350 | 1176 | 62.5 | 2.75 | 99.2 | 2395 | 91.9 | 2.04 |
| | 62/35/2/1 | 354 | 1186 | 62.5 | 2.74 | 99.1 | 2415 | 92.7 | 2.17 |
| | 60/35/4/1 | 361 | 1208 | 62.6 | 2.74 | 98.8 | 2453 | 94.2 | 2.42 |
| | 48/50/1/1 | 365 | 1221 | 63.8 | 2.75 | 99.2 | 2495 | 95.8 | 1.88 |
| | 92/5/1/2 | 325 | 1101 | 60.1 | 2.74 | 98.8 | 2224 | 85.4 | 3.13 |
| | 91/5/2/2 | 329 | 1113 | 60.2 | 2.73 | 98.7 | 2244 | 86.1 | 3.32 |
| | 89/5/4/2 | 336 | 1137 | 60.4 | 2.73 | 98.4 | 2286 | 87.8 | 18.34 |
| | 85/5/8/2 | 351 | 1186 | 60.7 | 2.71 | 97.9 | 2368 | 90.9 | 4.31 |
| | 87/10/1/2 | 333 | 1125 | 60.6 | 2.74 | 98.8 | 2272 | 87.2 | 3.20 |
| | 86/10/2/2 | 337 | 1137 | 60.7 | 2.73 | 98.6 | 2293 | 88.0 | 3.37 |
| | 84/10/4/2 | 344 | 1161 | 60.8 | 2.73 | 98.4 | 2334 | 89.6 | 3.70 |
| | 80/10/8/2 | 359 | 1209 | 61.1 | 2.71 | 97.9 | 2415 | 92.7 | 4.28 |
| | 77/20/1/2 | 347 | 1168 | 61.6 | 2.73 | 98.7 | 2362 | 90.7 | 3.25 |
| | 76/20/2/2 | 351 | 1180 | 61.6 | 2.73 | 98.6 | 2382 | 91.4 | 3.39 |
| | 74/20/4/2 | 358 | 1203 | 61.7 | 2.72 | 98.3 | 2422 | 93.0 | 3.66 |
| | 70/20/8/2 | 373 | 1250 | 62.0 | 2.71 | 97.8 | 2501 | 96.0 | 4.13 |
| | 62/35/1/2 | 366 | 1224 | 62.9 | 2.73 | 98.7 | 2481 | 95.2 | 3.15 |
| | 61/35/2/2 | 369 | 1235 | 62.9 | 2.73 | 98.6 | 2500 | 96.0 | 3.26 |
| | 59/35/4/2 | 376 | 1257 | 63.0 | 2.73 | 98.4 | 2538 | 97.4 | 3.48 |
| | 47/50/1/2 | 381 | 1270 | 64.1 | 2.74 | 98.7 | 2581 | 99.1 | 2.99 |
| HFC-1225ye/HFC-134a/HFC- | 93/5/1/1 | 312 | 1062 | 59.9 | 2.75 | 99.2 | 2155 | 82.7 | 2.23 |
| 125/HC-1270 | | | | | | | | | |
| | 92/5/2/1 | 316 | 1074 | 60.0 | 2.75 | 99.1 | 2176 | 83.5 | 2.44 |
| | 90/5/4/1 | 323 | 1098 | 60.2 | 2.74 | 98.9 | 2218 | 85.1 | 2.84 |
| | 86/5/8/1 | 338 | 1147 | 60.5 | 2.73 | 98.4 | 2302 | 88.4 | 3.56 |
| | 78/5/16/1 | 369 | 1245 | 61.0 | 2.70 | 97.3 | 2469 | 94.8 | 4.69 |
| | 88/10/1/1 | 320 | 1085 | 60.4 | 2.75 | 99.2 | 2203 | 84.6 | 2.31 |
| | 87/10/2/1 | 323 | 1097 | 60.5 | 2.75 | 99.1 | 2224 | 85.4 | 2.50 |
| | 85/10/4/1 | 331 | 1121 | 60.7 | 2.74 | 98.9 | 2266 | 87.0 | 2.87 |
| | 81/10/8/1 | 345 | 1169 | 60.9 | 2.73 | 98.4 | 2348 | 90.1 | 3.52 |
| | 73/10/16/1 | 374 | 1266 | 61.6 | 2.69 | 97.0 | 2501 | 96.0 | 4.54 |
| | 78/20/1/1 | 334 | 1127 | 61.4 | 2.75 | 99.2 | 2292 | 88.0 | 2.35 |
| | 77/20/2/1 | 337 | 1139 | 61.5 | 2.74 | 99.1 | 2312 | 88.8 | 2.51 |
| | 75/20/4/1 | 344 | 1162 | 61.6 | 2.74 | 98.8 | 2353 | 90.3 | 2.82 |
| | 71/20/8/1 | 359 | 1208 | 61.8 | 2.73 | 98.4 | 2433 | 93.4 | 3.37 |
| | 63/35/1/1 | 352 | 1182 | 62.7 | 2.75 | 99.2 | 2408 | 92.4 | 2.24 |
| | 62/35/2/1 | 355 | 1193 | 62.8 | 2.74 | 99.1 | 2428 | 93.2 | 2.37 |
| | 60/35/4/1 | 362 | 1215 | 62.9 | 2.74 | 98.8 | 2466 | 94.7 | 2.62 |
| | 48/50/1/1 | 366 | 1226 | 64.0 | 2.75 | 99.2 | 2507 | 96.2 | 2.05 |
| | 92/5/1/2 | 329 | 1116 | 60.7 | 2.74 | 98.8 | 2253 | 86.5 | 3.65 |
| | 91/5/2/2 | 332 | 1128 | 60.7 | 2.73 | 98.6 | 2274 | 87.3 | 3.84 |
| | 89/5/4/2 | 340 | 1153 | 60.9 | 2.72 | 98.3 | 2315 | 88.9 | 4.19 |
| | 85/5/8/2 | 355 | 1202 | 61.2 | 2.71 | 97.8 | 2398 | 92.1 | 4.82 |
| | 87/10/1/2 | 336 | 1140 | 61.1 | 2.74 | 98.7 | 2301 | 88.3 | 3.70 |
| | 86/10/2/2 | 340 | 1152 | 61.2 | 2.73 | 98.6 | 2321 | 89.1 | 3.87 |
| | 84/10/4/2 | 347 | 1176 | 61.4 | 2.72 | 98.2 | 2362 | 90.7 | 4.19 |
| | 80/10/8/2 | 362 | 1224 | 61.6 | 2.71 | 97.8 | 2444 | 93.8 | 4.76 |
| | 77/20/1/2 | 350 | 1182 | 62.0 | 2.73 | 98.7 | 2390 | 91.7 | 3.69 |
| | 76/20/2/2 | 354 | 1194 | 62.1 | 2.73 | 98.6 | 2409 | 92.5 | 3.83 |
| | 74/20/4/2 | 361 | 1217 | 62.2 | 2.72 | 98.3 | 2449 | 94.0 | 4.10 |
| | 70/20/8/2 | 376 | 1264 | 62.5 | 2.71 | 97.8 | 2529 | 97.1 | 4.57 |
| | 62/35/1/2 | 368 | 1237 | 63.3 | 2.73 | 98.7 | 2506 | 96.2 | 3.53 |
| | 61/35/2/2 | 372 | 1248 | 63.4 | 2.73 | 98.6 | 2525 | 96.9 | 3.64 |
| | 59/35/4/2 | 379 | 1270 | 63.5 | 2.72 | 98.3 | 2563 | 98.4 | 3.86 |
| | 47/50/1/2 | 383 | 1281 | 64.5 | 2.73 | 98.7 | 2605 | 100.0 | 3.32 |
| HFC-1225ye/HFC-134a/HFC- | 93/5/1/1 | 306 | 1044 | 60.1 | 2.76 | 99.6 | 2128 | 81.7 | 1.54 |
| 125/HFC-32 | | | | | | | | | |
| | 92/5/2/1 | 310 | 1056 | 60.2 | 2.76 | 99.5 | 2149 | 82.5 | 1.75 |
| | 90/5/4/1 | 317 | 1104 | 61.4 | 2.66 | 96.1 | 2165 | 83.1 | 2.13 |
| | 86/5/8/1 | 332 | 1127 | 60.6 | 2.74 | 98.8 | 2275 | 87.3 | 2.86 |
| | 78/5/16/1 | 362 | 1223 | 61.1 | 2.71 | 97.8 | 2442 | 93.7 | 3.99 |
| | 88/10/1/1 | 314 | 1066 | 60.6 | 2.76 | 99.6 | 2174 | 83.5 | 1.57 |
| | 87/10/2/1 | 317 | 1077 | 60.6 | 2.76 | 99.5 | 2195 | 84.3 | 1.76 |
| | 85/10/4/1 | 324 | 1101 | 60.8 | 2.75 | 99.2 | 2236 | 85.8 | 2.12 |
| | 81/10/8/1 | 339 | 1148 | 61.0 | 2.74 | 98.8 | 2319 | 89.0 | 2.78 |
| | 73/10/16/1 | 369 | 1243 | 61.5 | 2.71 | 97.8 | 2483 | 95.3 | 3.81 |
| | 78/20/1/1 | 327 | 1106 | 61.5 | 2.76 | 99.5 | 2258 | 86.7 | 1.52 |
| | 77/20/2/1 | 330 | 1117 | 61.6 | 2.75 | 99.4 | 2279 | 87.5 | 1.69 |
| | 75/20/4/1 | 337 | 1139 | 61.7 | 2.75 | 99.2 | 2319 | 89.0 | 2.00 |
| | 63/35/1/1 | 352 | 1185 | 61.9 | 2.74 | 98.8 | 2399 | 92.1 | 2.55 |
| | 62/35/2/1 | 344 | 1157 | 62.8 | 2.76 | 99.5 | 2369 | 90.9 | 1.31 |
| | 60/35/4/1 | 347 | 1167 | 62.9 | 2.76 | 99.5 | 2388 | 91.7 | 1.45 |
| | 48/50/1/1 | 354 | 1189 | 63.0 | 2.75 | 99.2 | 2427 | 93.2 | 1.70 |
| | 92/5/1/2 | 357 | 1198 | 64.0 | 2.76 | 99.6 | 2462 | 94.5 | 1.05 |
| | 91/5/2/2 | 318 | 1084 | 61.0 | 2.76 | 99.5 | 2207 | 84.7 | 2.50 |
| | 89/5/4/2 | 321 | 1096 | 61.1 | 2.75 | 99.4 | 2228 | 85.5 | 2.68 |
| | 85/5/8/2 | 328 | 1119 | 61.2 | 2.75 | 99.1 | 2269 | 87.1 | 3.03 |
| | 77/5/16/2 | 343 | 1166 | 61.4 | 2.73 | 98.7 | 2352 | 90.3 | 3.65 |
| | 87/10/1/2 | 373 | 1262 | 61.9 | 2.71 | 97.7 | 2515 | 96.5 | 4.61 |
| | 86/10/2/2 | 325 | 1104 | 61.4 | 2.76 | 99.5 | 2251 | 86.4 | 2.45 |
| | 84/10/4/2 | 328 | 1116 | 61.5 | 2.75 | 99.4 | 2271 | 87.2 | 2.61 |
| | 80/10/8/2 | 335 | 1139 | 61.6 | 2.75 | 99.1 | 2312 | 88.8 | 2.93 |
| | 72/10/16/2 | 350 | 1185 | 61.9 | 2.73 | 98.7 | 2393 | 91.9 | 3.50 |
| | 77/20/1/2 | 380 | 1280 | 62.3 | 2.71 | 97.7 | 2555 | 98.1 | 4.37 |
| | 76/20/2/2 | 337 | 1142 | 62.3 | 2.76 | 99.5 | 2331 | 89.5 | 2.27 |
| | 74/20/4/2 | 341 | 1153 | 62.4 | 2.75 | 99.4 | 2351 | 90.2 | 2.41 |
| | 70/20/8/2 | 348 | 1175 | 62.5 | 2.75 | 99.3 | 2390 | 91.7 | 2.68 |
| | 62/35/1/2 | 362 | 1220 | 62.7 | 2.73 | 98.6 | 2469 | 94.8 | 3.16 |
| | 61/35/2/2 | 353 | 1189 | 63.5 | 2.76 | 99.5 | 2435 | 93.5 | 1.91 |
| | 59/35/4/2 | 357 | 1200 | 63.6 | 2.75 | 99.4 | 2455 | 94.2 | 2.03 |
| | 47/50/1/2 | 364 | 1221 | 63.7 | 2.75 | 99.2 | 2493 | 95.7 | 2.25 |
| | 90/5/1/4 | 366 | 1228 | 64.7 | 2.76 | 99.5 | 2523 | 96.9 | 1.55 |
| | 89/5/2/4 | 339 | 1161 | 62.7 | 2.75 | 99.2 | 2358 | 90.5 | 4.12 |
| | 87/5/4/4 | 343 | 1172 | 62.8 | 2.74 | 99.1 | 2378 | 91.3 | 4.26 |
| | 83/5/8/4 | 350 | 1195 | 62.9 | 2.74 | 98.8 | 2418 | 92.8 | 4.51 |
| | 85/10/1/4 | 365 | 1242 | 63.1 | 2.72 | 98.3 | 2498 | 95.9 | 4.97 |
| | 84/10/2/4 | 346 | 1179 | 63.1 | 2.75 | 99.2 | 2397 | 92.0 | 3.94 |
| | 82/10/4/4 | 349 | 1190 | 63.1 | 2.74 | 99.1 | 2417 | 92.8 | 4.06 |
| | 78/10/8/4 | 356 | 1213 | 63.2 | 2.74 | 98.8 | 2457 | 94.3 | 4.30 |
| | 75/20/1/4 | 371 | 1258 | 63.4 | 2.73 | 98.4 | 2536 | 97.4 | 4.71 |
| | 74/20/2/4 | 358 | 1211 | 63.9 | 2.75 | 99.2 | 2470 | 94.8 | 3.54 |
| | 72/20/4/4 | 361 | 1222 | 63.9 | 2.75 | 99.1 | 2489 | 95.5 | 3.65 |
| | 68/20/8/4 | 368 | 1244 | 64.0 | 2.74 | 98.9 | 2528 | 97.0 | 3.85 |
| | 60/35/1/4 | 383 | 1289 | 64.2 | 2.73 | 98.4 | 2605 | 100.0 | 4.20 |
| | 59/35/2/4 | 372 | 1253 | 65.0 | 2.75 | 99.3 | 2564 | 98.4 | 1.82 |
| | 57/35/4/4 | 376 | 1263 | 65.0 | 2.75 | 99.2 | 2583 | 99.2 | 3.03 |

Many compositions in Table 3 have similar energy efficiency (COP) as compared to HFC-134a while maintaining lower discharge pressures and temperatures. Refrigeration capacity for several of the compositions listed in Table 3 is also similar to R134a indicating these compositions could be replacement refrigerants for R134a in refrigeration and air-conditioning. Additionally, several of the compositions have low average glide thus allowing use in flooded evaporator type chillers.

1. A composition selected from the group consisting of:
a. about 50 weight percent to about 99 weight percent 1,2,3,3,3-pentafluoropropene and about 50 weight percent to about 1 weight percent 2,3,3,3-tetrafluoropropene;
b. 1,2,3,3,3-pentafluoropropene and pentafluoroethane;
c. 1,2,3,3,3-pentafluoropropene and cyclopropane;
d. 1,2,3,3,3-pentafluoropropene and propylene;
e. 1,2,3,3,3-pentafluoropropene and fluoroethane;
f. 1,2,3,3,3-pentafluoropropene and propylene;
g. 1,2,3,3,3-pentafluoropropene, 1,1,1,2-tetrafluoroethane and pentafluoroethane;
h. 1,2,3,3,3-pentafluoropropene, 1,1,1,2-tetrafluoroethane, and fluoroethane;
i. 1,2,3,3,3-pentafluoropropene, 1,1,1,2-tetrafluoroethane, and cyclopropane;
j. 1,2,3,3,3-pentafluoropropene, 1,1,1,2-tetrafluoroethane, and ammonia;
k. 1,2,3,3,3-pentafluoropropene, 1,1,1,2-tetrafluoroethane, and propylene;
l. 1,2,3,3,3-pentafluoropropene, 1,1,1,2-tetrafluoroethane, pentafluoroethane, and ammonia;
m. 1,2,3,3,3-pentafluoropropene, 1,1,1,2-tetrafluoroethane, pentafluoroethane, and cyclopropane;
n. 1,2,3,3,3-pentafluoropropene, 1,1,1,2-tetrafluoroethane, pentafluoroethane, and propane;
o. 1,2,3,3,3-pentafluoropropene, 1,1,1,2-tetrafluoroethane, pentafluoroethane, and propylene; or
p. 1,2,3,3,3-pentafluoropropene, 1,1,1,2-tetrafluoroethane, pentafluoroethane, and difluoromethane.

2. A composition selected from the group consisting of a., b. or c., where the composition consists essentially of:
a. 1,2,3,3,3-pentafluoropropene and pentafluoroethane;
b. 1,2,3,3,3-pentafluoropropene and ammonia; or
c. 1,2,3,3,3-pentafluoropropene and 1,1,-difluoroethane.

3. The composition of claim 1, further comprising a lubricant selected from the group consisting of polyalkylene glycols, polyol esters, polyvinylethers, mineral oils, alkylbenzenes, synthetic paraffins, synthetic naphthenes, or poly(alpha)olefins.

4. The composition of claim 1, further comprising at least one additive selected from the group consisting of compatibilizers, UV dyes, solubilizing agents, tracers, stabilizers, perfluoropolyethers or functionalized perfluoropolyethers.

5. The composition of claim 1, selected from the group consisting of:
a. about 80 weight percent to about 99 weight percent 1,2,3,3,3-pentafluoropropene and about 20 weight percent to about 1 weight percent pentafluoroethane;
b. about 90 weight percent to about 99 weight percent 1,2,3,3,3-pentafluoropropene and about 10 weight percent to about 1 weight percent cyclopropane;
c. about 90 weight percent to about 99 weight percent 1,2,3,3,3-pentafluoropropene and about 10 weight percent to about 1 weight percent propylene;
d. about 90 to about 99 weight percent 1,2,3,3,3-pentafluoropropene and about 1 to about 10 weight percent fluoroethane;
e. about 90 to about 99 weight percent 1,2,3,3,3-pentafluoropropene and about 1 to about 10 weight percent ammonia;
f. about 90 to about 99 weight percent 1,2,3,3,3-pentafluoropropene and about 1 to about 10 weight percent propylene;
g. about 40 weight percent to about 98 weight percent 1,2,3,3,3-pentafluoropropene, about 1 weight percent to about 50 weight percent 1,1,1,2-tetrafluoroethane and about 1 weight percent to about 20 weight percent pentafluoroethane;
h. about 40 weight percent to about 98 weight percent 1,2,3,3,3-pentafluoropropene, about 1 weight percent to about 50 weight percent 1,1,1,2-tetrafluoroethane, and about 1 weight percent to about 10 weight percent fluoroethane;
i. about 40 weight percent to about 98 weight percent 1,2,3,3,3-pentafluoropropene, about 1 weight percent to about 50 weight percent 1,1,1,2-tetrafluoroethane, and about 1 weight percent to about 10 weight percent cyclopropane;
j. about 40 weight percent to about 98 weight percent 1,2,3,3,3-pentafluoropropene, about 1 weight percent to about 50 weight percent 1,1,1,2-tetrafluoroethane, and about 1 weight percent to about 5 weight percent ammonia;
k. about 40 weight percent to about 98 weight percent 1,2,3,3,3-pentafluoropropene, about 1 weight percent to about 50 weight percent 1,1,1,2-tetrafluoroethane, and about 1 weight percent to about 5 weight percent propylene;
l. about 40 weight percent to about 97 weight percent 1,2,3,3,3-pentafluoropropene, about 1 weight percent to about 50 weight percent 1,1,1,2-tetrafluoroethane, about 1 weight percent to about 20 weight percent pentafluoroethane, and about 1 weight percent to about 5 weight percent ammonia;
m. about 40 weight percent to about 97 weight percent 1,2,3,3,3-pentafluoropropene, about 1 weight percent to about 50 weight percent 1,1,1,2-tetrafluoroethane, about 1 weight percent to about 20 weight percent pentafluoroethane, and about 1 weight percent to about 5 weight percent cyclopropane;
n. about 40 weight percent to about 97 weight percent 1,2,3,3,3-pentafluoropropane, about 1 weight percent to about 50 weight percent 1,1,1,2-tetrafluoroethane, about 1 weight percent to about 20 weight percent pentafluoroethane, and about 1 weight percent to about 5 weight percent propane;
o. about 40 weight percent to about 97 weight percent 1,2,3,3,3-pentafluoropropene, about 1 weight percent to about 50 weight percent 1,1,1,2-tetrafluoroethane, about 1 weight percent to about 20 weight percent pentafluoroethane, and about 1 weight percent to about 5 weight percent propylene; or
p. about 40 weight percent to about 97 weight percent 1,2,3,3,3-pentafluoropropene, about 1 weight percent to about 50 weight percent 1,1,1,2-tetrafluoroethane, about 1 weight percent to about 20 weight percent pentafluoroethane, and about 1 weight percent to about 10 weight percent difluoromethane.

6. The composition of claim 2, where the composition consists essentially of:
a. about 80 weight percent to about 99 weight percent 1,2,3,3,3 pentafluoropropene and about 1 weight percent to about 20 weight pentafluoroethane;
b. about 90 weight percent to about 99 weight percent 1,2,3,3,3-pentafluoropropene and about 1 weight percent to about 10 weight ammonia; or
c. about 90 weight percent to about 99 weight percent 1,2,3,3,3-pentafluoropropene and about 1 weight percent to about 10 weight percent 1,1,-difluoroethane.

7. A method for producing cooling in a mobile air conditioning system, comprising evaporating the composition of claim 1 in the vicinity of a body to be cooled, and thereafter condensing said composition, wherein the composition is a refrigerant.

8. A method for producing cooling in a flooded evaporator chiller, comprising passing a cooling medium through an evaporator, evaporating the composition of claim 1, to form a vapor, thereby cooling the cooling medium, and passing the cooling medium out of the evaporator to a body to be cooled.

9. A method for producing cooling in a direct expansion chiller comprising passing a composition of claim 1 through an evaporator, evaporating a cooling medium in the evaporator to form a cooling medium vapor, thereby cooling the composition, and passing the composition out of the evaporator to a body to be cooled.

10. (canceled)

11. A method for producing cooling in (i) a flooded evaporator chiller, comprising passing a cooling medium through an evaporator, evaporating a composition to form a vapor, thereby cooling the cooling medium, and passing the cooling medium out of the evaporator to a body to be cooled, or (ii) a direct expansion chiller comprising passing a composition through an evaporator, evaporating a cooling medium in the evaporator to form a cooling medium vapor, thereby cooling the composition, and passing the composition out of the evaporator to a body to be cooled, wherein the composition is selected from the group consisting of:
a. 1,2,3,3,3-pentafluoropropene and difluoromethane;
b. 1,2,3,3,3-pentafluoropropene and pentafluoroethane;
c. 1,2,3,3,3-pentafluoropropene and 1,1,1,2-tetrafluoroethane;
d. 1,2,3,3,3-pentafluoropropene and 1,1,difluoroethane
e. 1,2,3,3,3-pentafluoropropene and cyclopropane;
f. 1,2,3,3,3-pentafluoropropene and propane;
g. 1,2,3,3,3-pentafluoropropene, 2,3,3,3,-tetrafluoropropene and 1,1,1,2-tetrafluoroethane;
h. 1,2,3,3,3-pentafluoropropene, 1,1,1,2-tetrafluoroethane and difluoromethane;
i. 1,2,3,3,3-pentafluoropropene, 1,1,1,2-tetrafluoroethane and 1,1,difluoroethane;
j. 1,2,3,3,3-pentafluoropropene, 1,1,1,2-tetrafluoroethane and fluoroethane; or
k. 1,2,3,3,3-pentafluoropropene, 1,1,1,2-tetrafluoroethane and propane.

12. (canceled)

13. (canceled)

14. The method of claim 11, wherein said composition is selected from the group consisting of:
a. about 80 weight percent to about 99 weight percent 1,2,3,3,3-pentafluoropropene and about 20 weight percent to about 1 weight percent difluoromethane;
b. about 80 weight percent to about 99 weight percent 1,2,3,3,3-pentafluoropropane and about 20 weight percent to about 1 weight percent pentafluoroethane;
c. about 50 weight percent to about 99 weight percent 1,2,3,3,3-pentafluoropropene and about 50 weight percent to about 1 weight percent 1,1,1,2-tetrafluoroethane;
d. about 90 weight percent to about 99 weight percent 1,2,3,3,3-pentafluoropropene and about 10 weight percent to about 1 weight percent 1,1-difluoroethane;
e. about 90 weight percent to about 99 weight percent 1,2,3,3,3-pentafluoropropane and about 10 weight percent to about 1 weight percent cyclopropane;
f. about 90 weight percent to about 99 weight percent 1,2,3,3,3-pentafluoropropene and about 10 weight percent to about 1 weight percent propane;
g. about 1 weight percent to about 60 weight percent 1,2,3,3,3-pentafluoropropene, about 20 weight percent to about 50 weight percent 1,1,1,2-tetrafluoroethane, and about 1 weight percent to about 50 weight percent 2,3,3,3-tetrafluoropropene;
h. about 40 weight percent to about 98 weight percent 1,2,3,3,3-pentafluoropropene, about 1 weight percent to about 50 weight percent 1,1,1,2-tetrafluoroethane, and about 1 weight percent to about 10 weight percent difluoromethane;
i. about 40 weight percent to about 98 weight percent 1,2,3,3,3-pentafluoropropene, about 1 weight percent to about 50 weight percent 1,1,1,2-tetrafluoroethane, and about 1 weight percent to about 10 weight percent 1,1,-difluoroethane;
j. about 40 weight percent to about 98 weight percent 1,2,3,3,3-pentafluoropropane, about 1 weight percent to about 50 weight percent 1,1,1,2-tetrafluoroethane, and about 1 weight percent to about 10 weight percent fluoroethane; or
k. about 40 weight percent to about 98 weight percent 1,2,3,3,3-pentafluoropropene, about 1 weight percent to about 50 weight percent 1,1,1,2-tetrafluoroethane, and about 1 weight percent to about 5 weight percent propane.

15. The method of claim 8, further comprising compressing said composition prior to condensing, and wherein said compressing occurs in a centrifugal, screw, scroll or reciprocating compressor.

16. A method for producing cooling in a mobile air conditioning system, comprising evaporating the composition of claim 2 in the vicinity of a body to be cooled, and thereafter condensing said composition, wherein the composition is a refrigerant.

17. A method for producing cooling in a flooded evaporator chiller, comprising passing a cooling medium through an evaporator, evaporating the composition of claim 2 to form a vapor, thereby cooling the cooling medium, and passing the cooling medium out of the evaporator to a body to be cooled.

18. A method for producing cooling in a direct expansion chiller comprising passing a composition of claim 2 through an evaporator, evaporating a cooling medium in the evaporator to form a cooling medium vapor, thereby cooling the composition, and passing the composition out of the evaporator to a body to be cooled.

19. The method of claim 9, further comprising compressing said composition prior to condensing, and wherein said compressing occurs in a centrifugal, screw, scroll or reciprocating compressor.

20. The method of claim 11, further comprising compressing said composition prior to condensing, and wherein said compressing occurs in a centrifugal, screw, scroll or reciprocating compressor.
